(19) United States
(12) Patent Application Publication
(10) Pub. No.: US 2023/0087643 A1
(43) Pub. Date: Mar. 23, 2023

(54) METHOD AND APPARATUS FOR DETERMINING COUPLING SECTION IN REAL-TIME FOR TRAIN PLATOONING

(71) Applicant: KOREA RAILROAD RESEARCH INSTITUTE, Uiwang-si (KR)

(72) Inventors: Suk Mun OH, Gwangmyeong-si (KR); Ho Chan KWAK, Seoul (KR); Ji Young SONG, Yongin-si (KR); Rag Gyo JEONG, Seoul (KR)

(73) Assignee: KOREA RAILROAD RESEARCH INSTITUTE, Uiwang-si (KR)

(21) Appl. No.: 17/830,866

(22) Filed: Jun. 2, 2022

(30) Foreign Application Priority Data
Sep. 17, 2021 (KR) 10-2021-0124861
Sep. 17, 2021 (KR) 10-2021-0125100

(51) Int. Cl. B61L 25/02; B61L 27/14; G08G 1/123; G08G 1/00

(52) U.S. Cl. CPC B61L 25/028; B61L 25/021; B61L 27/14; G08G 1/123; G08G 1/20; G08G 1/22

(57) ABSTRACT

The present disclosure provides a method and apparatus for determining coupling and decoupling positions between trains. In at least one embodiment, the present disclosure provides a method performed by an apparatus for determining coupling and decoupling positions between trains, the method comprising collecting performance data, simulation data, and real-time data, calculating a first parameter and a second parameter, and determining the coupling and decoupling positions between the trains.

### CROSS-REFERENCE TO RELATED APPLICATIONS

This application is based on, and claims priority from, Korean Patent Application Number 10-2021-0124861, filed on Sep. 17, 2021, and 10-2021-0125100, filed on Sep. 17, 2021, the disclosures of which are incorporated by reference herein in their entireties.

### TECHNICAL FIELD

The present disclosure in some embodiments relates to a method of and an apparatus for determining a coupling section in real-time for train platooning.

### BACKGROUND

The statements in this section merely provide background information related to the present disclosure and do not necessarily constitute prior art.

A subway line interconnecting a suburban area and an urban area usually experiences a decrease in the traffic volume in the latter part of the line or concentration of passengers boarding and alighting in the urban area. When utilizing the same amount of train resources in the urban area and the suburb, the transit suffers from the inability to meet the rapid increase of passenger demand in the urban area. On the other hand, the suburb sees decreased use of trains, resulting in surplus resources.

To efficiently utilize train resources in response to passenger demand, a shuttle operation method may be used. Shuttle operation is a method of reciprocating trains in a preset route section. However, due to its periodical simple routine over a preset section, the shuttle operation cannot tackle an exceptional circumstance in real-time in which passenger demand rapidly changes, which is disadvantageous.

To increase or decrease the number of train cars may involve the technology of decoupling and coupling between trains based on wireless communication. Specifically, virtual coupling and decoupling between trains may be performed based on Vehicle-to-Vehicle (V2V) communications between a train and a neighboring train or Vehicle-to-Infrastructure (V2I) communications between a train and a ground control device.

However, the prior art regarding the virtual coupling and decoupling between trains is short of presenting a specific method of determining whether coupling and decoupling are necessary between a preceding train and the following train and a concrete method of determining the positions of coupling and decoupling between trains for implementing platooning.

Meanwhile, in the operation of an urban train, trains each traveling on a diverging track may join at a joint station. The joint station may be a criterion for classifying a suburban area and an urban area. Multiple trains run in an urban area after the joint station on a joint route. To efficiently use limited train resources, the multiple trains may perform platooning by using interval control technology. For example, a preceding train entering the joint station from one track and the following train entering the joint station from another track may perform virtual coupling to perform platooning.

However, the prior art related to the virtual coupling at the joint station is dictated by safety issues to generally limit the position where the preceding train and the following train perform coupling to the range of the platform of the joint station. However, the limitation of the coupling position to the inside of the platform combined with an exceptional circumstance involving operation delay of the preceding train or the following train deteriorates the efficiency of the use of tracks.

Therefore, there is a dire need for a technology for determining the coupling position in real-time between trains for recovery of platooning when a train deviates from a joint schedule, for allowing the preceding train and the following train to perform coupling even on a track other than the joint station.

### SUMMARY

According to at least one embodiment, the present disclosure provides a method performed by an apparatus for determining coupling and decoupling positions between trains, the method including the steps (not necessarily in the following order) of (i) collecting performance data on operation performance and dispatch performance of a train, simulation data on a situation not recorded in the performance data on operation performance and dispatch performance of the train, and real-time data on passenger information and train operation information recorded in real-time, (ii) calculating, by using at least one of the performance data, the simulation data, the real-time data, and schedule data that is preset on operation and dispatch of the train, a first parameter for determining whether a train is saturated and a second parameter for determining whether a railway traffic condition corresponds to an exceptional circumstance, and (iii) determining the coupling and decoupling positions between the trains based on the first parameter and the second parameter.

According to another embodiment, the present disclosure provides an apparatus for determining coupling and decoupling positions between trains, including a data collection unit, a parameter calculation unit, and a position determination unit. The data collection unit is configured to collect performance data on operation performance and dispatch performance of a train, simulation data on a situation not recorded in the performance data on operation performance and dispatch performance of the train, and real-time data on passenger information and train operation information recorded in real-time. The parameter calculation unit is configured to calculate a first parameter for determining whether a train is saturated and a second parameter for determining whether the railway traffic condition corresponds to an exceptional circumstance by using at least one of the performance data, the simulation data, the real-time data, and schedule data that is preset on operation and dispatch of the train. The position determination unit is configured to determine the coupling and decoupling positions between the trains based on the first parameter and the second parameter.

According to yet another embodiment, the present disclosure provides a non-transitory computer-readable recording medium having recorded thereon a program which when executed by a processor, causes the processor to perform operations comprising: collecting performance data on operation performance and dispatch performance of a train, simulation data on a situation not recorded in the performance data on operation performance and dispatch performance of the train, and real-time data on passenger information and train operation information recorded in real-time; calculating a first parameter for determining whether a train is saturated and a second parameter for determining whether a railway traffic condition corresponds to an exceptional circumstance by using at least one of the performance data, the simulation data, the real-time data, and schedule data that is preset on operation and dispatch of the train; and determining a coupling and decoupling positions between the trains based on the first parameter and the second parameter.

According to yet another embodiment, the present disclosure provides a method performed by an apparatus for determining a coupling position between trains, the method including the steps (not necessarily in the following order) of (i) calculating, by using simulation input data that is pre-stored, real-time estimation data including an estimated arrival time at which at least one train is expected to arrive at a joint station and a delay estimation value of the train, (ii) classifying a present situation into a normal circumstance or an exceptional circumstance by comparing the real-time estimation data with at least one exceptional circumstance threshold for determining an exceptional circumstance, (iii) performing a preceding train determination by a comparison of estimated arrival times between a first train that is planned to enter the joint station first according to an operation schedule and a second train that is planned to enter the joint station subsequently and couple with the first train according to the operation schedule, to determine a preceding train and a following train, (iv) determining a preceding-train departure time for the preceding train to depart from the joint station by using a delay estimation value of the following train, and (v) determining the coupling position between the preceding train and the following train to start platooning.

According to yet another embodiment, the present disclosure provides an apparatus for determining a coupling position between trains, including an arrival time calculation unit, a circumstance determining unit, a preceding train determining unit, a departure time determining unit, and a coupling position determining unit. The arrival time calculation unit is configured to calculate, by using simulation input data that is pre-stored, real-time estimation data including an estimated arrival time at which at least one train is expected to arrive at a joint station, and a delay estimation value of the train. The circumstance determining unit is configured to classify a present situation into a normal circumstance or an exceptional circumstance by comparing the real-time estimation data with at least one exceptional circumstance threshold for determining an exceptional circumstance. The preceding train determining unit is configured to perform a comparison of estimated arrival times between a first train that is planned to enter the joint station first according to an operation schedule and a second train that is planned to enter the joint station subsequently and couple with the first train according to the operation schedule, to determine a preceding train and the following train. The departure time determining unit is configured to determine a preceding-train departure time for the preceding train to depart from the joint station by using a delay estimation value of the following train. The coupling position determining unit is configured to determine the coupling position between the preceding train and the following train to start platooning.

According to yet another embodiment, the present disclosure provides a non-transitory computer-readable recording medium having recorded thereon a program which when executed by a processor, causes the processor to perform operations comprising: calculating real-time estimation data including an estimated arrival time at which at least one train is expected to arrive at a joint station and a delay estimation value of the train by using simulation input data that is pre-stored; classifying a present situation into a normal circumstance or an exceptional circumstance by comparing the real-time estimation data with at least one exceptional circumstance threshold for determining an exceptional circumstance; determining a preceding train and a following train by a comparison of estimated arrival times between a first train that is planned to enter the joint station first according to an operation schedule and a second train that is planned to enter the joint station subsequently and couple with the first train according to the operation schedule; determining a preceding-train departure time for the preceding train to depart from the joint station by using a delay estimation value of the following train; and determining a coupling position between the preceding train and the following train to start platooning.

### BRIEF DESCRIPTION OF THE DRAWINGS

FIG. 1 is a block diagram illustrating a coupling and decoupling (coupling/decoupling) position determination apparatus according to at least one embodiment of the present disclosure.

FIGS. 2A to 2C illustrate a method of determining coupling and decoupling positions according to at least one embodiment performing an embodiment variation of couplings between preceding trains and following trains at coupling/decoupling positions.

FIG. 3 is a block diagram for explaining respective components included in a position determination unit according to at least one embodiment.

FIG. 4 is a graph illustrating the coupling/decoupling position determination apparatus according to at least one embodiment determining in an embodiment variation the coupling and decoupling positions in response to passenger demand in ordinary or exceptional circumstances.

FIG. 5 is a diagram illustrating a grouping of multiple dwell stations existing between coupling and decoupling positions according to an embodiment variation.

FIG. 6 is a diagram illustrating cases of performing coupling and decoupling by the operation of the coupling/decoupling position determination apparatus according to some embodiment variations.

FIG. 7 is a flowchart of a method of determining coupling and decoupling positions according to at least one embodiment.

FIG. 8 is a flowchart of a position determining process included in the method of determining coupling and decoupling positions according to at least one embodiment.

FIG. 9 is a conceptual diagram for explaining components included in a coupling position determining system according to at least one embodiment of the present disclosure.

FIGS. 10A to 100 illustrate a coupling position determining method according to at least one embodiment by an embodiment variation wherein a first train waits until a second train enters a joint station, when and where the first train performs coupling with the second train.

FIGS. 11A and 11B illustrate a coupling position determining method according to at least one embodiment by an embodiment variation wherein the first train departs first without waiting for the second train and thereafter performs coupling with the second train at a coupling position calculated according to the present disclosure.

FIG. 12 is a block diagram of components included in the coupling position determining apparatus according to at least one embodiment.

FIGS. 13A and 13B illustrate a first exceptional circumstance which is an operating condition of the coupling position determining method according to at least one embodiment.

FIGS. 14A and 14B illustrate a second exceptional circumstance which is an operating condition of the coupling position determining method according to at least one embodiment.

FIGS. 15A and 15B illustrate a third exceptional circumstance which is an operating condition of the coupling position determining method according to at least one embodiment.

FIG. 16 illustrates a method of calculating an optimal driving speed of the preceding train to determine the coupling position in the coupling position determining method according to at least one embodiment.

FIG. 17 is a flowchart illustrating the respective steps of the coupling position determining method according to at least one embodiment.

FIG. 18 is a flowchart illustrating substeps of a real-time estimation data calculation step in the coupling position determining method according to at least one embodiment.

FIG. 19 is a flowchart illustrating substeps of a coupling position determination step in the coupling position determining method according to at least one embodiment.

REFERENCE NUMERALS

| | |
|---|---|
| 200_A: first preceding train | 200_B: second preceding train |
| 202_A: first following train | 202_B: second following train |
| 900: preceding train | 902: following train |
| 1000: first train | 1002: second train |

### DETAILED DESCRIPTION

The present disclosure in at least one aspect seeks to provide a technology for determining a route section for platooning between trains in response to passenger demand that changes in real-time depending on whether the trains are in an urban or suburban area or whether they are in a normal or exceptional circumstance.

Hereinafter, some embodiments of the present disclosure will be described in detail with reference to the accompanying drawings. In the following description, like reference numerals preferably designate like elements, although the elements are shown in different drawings. Further, in the following description of some embodiments, a detailed description of related known components and functions when considered obscuring the subject of the present disclosure will be omitted for the purpose of clarity and for brevity.

Additionally, various terms such as first, second, A, B, (a), (b), etc., are used solely for the purpose of differentiating one component from others but not to imply or suggest the substances, the order or sequence of the components. Throughout this specification, when parts “include” or “comprise” a component, they are meant to further include other components, not excluding thereof unless there is a particular description contrary thereto. The terms such as “unit,” “module,” and the like refer to units for processing at least one function or operation, which may be implemented by hardware, software, or a combination thereof.

The description of the present disclosure to be presented below in conjunction with the accompanying drawings is intended to describe exemplary embodiments of the present disclosure and is not intended to represent the only embodiments in which the technical idea of the present disclosure may be practiced.

### Embodiment 1

The present disclosure provides a technique for determining a train platooning route section for efficiently using train resources. Specifically, a position determination apparatus according to the first embodiment determines whether coupling or decoupling is required between trains by using a first parameter regarding whether a train is saturated and a second parameter regarding whether or not an exceptional circumstance is present. The position determination apparatus determines coupling and decoupling positions to tackle passenger demand, and updates a dispatch plan based on the determined coupling and decoupling positions. The position determination technology according to the present disclosure adjusts train capacity in response to a change in passenger demand according to a train operation route or occurrence of an exceptional circumstance, thereby improving the efficiency of train resources. The present disclosure may be applied to various types of train services that interconnect suburban areas and urban areas.

In the first embodiment, coupling refers to a state in which a preceding train and the following train when running maintain a distance within a certain range. For example, the preceding train transmits and receives information to and from an Automatic Train Supervision (ATS) or the following train based on Vehicle-to-Vehicle (V2V) or Vehicle-to-Infrastructure (V2I) communications. The preceding train may be organized as a single group with the following train based on the information transmitted/received to and from the ATS or the following train. Accordingly, in the present disclosure, the coupling does not necessarily mean a physical coupling formed between trains by using a mechanical device and may be a logical coupling based on wireless communications.

In the first embodiment, decoupling may be logical decoupling for the preceding train and the following train running in a coupled state to run as independent groups, respectively. In the present disclosure, coupling and decoupling between trains may be implemented by using a train-sets control technique for virtual coupling/decoupling.

In the first embodiment, the preceding train means a leading train that runs when performing coupling. The following train means a train running after the preceding train to couple with the preceding train.

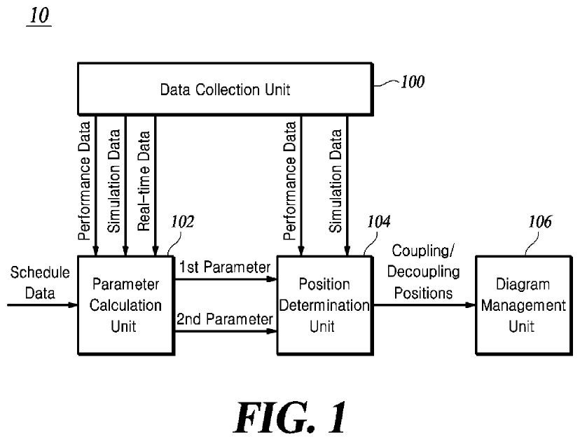

FIG. 1 is a block diagram illustrating a coupling and decoupling (coupling/decoupling) position determination apparatus 10 according to at least one embodiment of the present disclosure.

The coupling/decoupling position determination apparatus 10 according to at least one embodiment of the present disclosure includes a data collection unit 100, a parameter calculation unit 102, a position determination unit 104, and a dispatch plan management unit or diagram management unit 106 in whole or in part. The coupling/decoupling position determination apparatus 10 shown in FIG. 1 is according to at least one embodiment of the present disclosure, and not all blocks shown in FIG. 1 are requisite components, and in some other embodiments, some blocks included in the coupling/decoupling position determination apparatus 10 may be added, changed, or deleted. For example, the coupling/decoupling position determination apparatus 10 may further include a communications unit (not shown) for transmitting and receiving information with at least one of a ground communications device, an ATS (Automatic Train Supervision), and a train. A specific method for the communications unit to transmit/receive information to and from another device in the V2V communication or V2I communication method is common in the art, and a detailed description thereof will be omitted. In at least one embodiment, the coupling/decoupling position determination apparatus 10 may be mounted on a train running on the track. When the coupling/decoupling position determination apparatus 10 operates as an onboard device, it can communicate with other trains without ATS intervention, thereby reducing communication latency and enhancing connectivity. In another embodiment, the coupling/decoupling position determination apparatus 10 may be mounted on the ATS. The coupling/decoupling position determination apparatus 10 receives real-time location information from at least one train operating on the same route based on wireless communications. The coupling/decoupling position determination apparatus 10 receives gate entrance and exit information from at least one station located on the same route by using wired or wireless communications. The coupling/decoupling position determination apparatus 10 is responsive to when a shortage or surplus of train capacity occurs due to an increase or decrease in passenger demand for causing coupling or decoupling to be performed between the preceding train and the following train at a location where the change in passenger demand is large, thereby increasing or decreasing the train capacity.

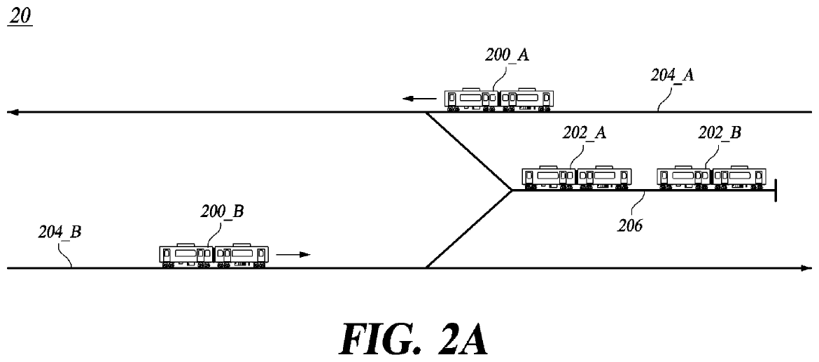

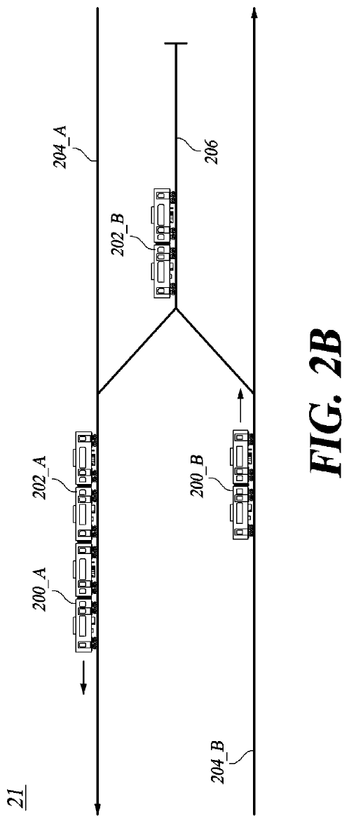

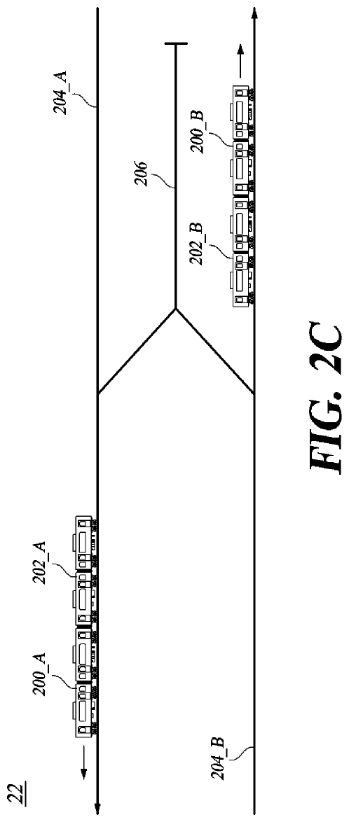

FIGS. 2A to 2C illustrate a coupling/decoupling position determination method according to at least one embodiment performing an embodiment variation (20-22) of couplings between preceding trains and following trains at coupling/decoupling positions. The following describes the embodiment variation (20-22) in which the preceding trains and the following trains perform coupling by time with reference to FIG. 2.

As shown in FIG. 2A, a first preceding train 200_A is running on an upper track 204_A. The second preceding train 200_B is running on a lower track 204_B. A first following train 202_A and a second following train 202_B are waiting on a wait track 206 (20). The upper track 204_A and the lower track 204_B mean tracks in opposite directions on the same line. The upper track 204_A and the lower track 204_B may be referred to as main lines. The wait track 206 means a track on which the following trains 202_A, 202_B wait for coupling with the preceding trains 200_A, 200_B, or a track on which the following trains 202_A, 202_B stand by after decoupling from the preceding trains 200_A, 200_B. The present disclosure assumes that the wait track 206 is pre-installed in a plurality of route sections where the amount of change in passenger demand is greater than a preset reference value based on performance data. The present disclosure may have taken into account the performance data and preset the coupling position where the following trains 202_A, 202_B started from the wait track 206 perform coupling with one or more preceding trains, and preset the decoupling position where the following trains 202_A, 202_B are decoupled from one or more preceding trains before entering the wait track 206. For example, for trains passing through an operation section [s], the coupling/decoupling position determination apparatus 10 may determine, from a combination of preset coupling positions and preset decoupling positions, a combination of new coupling and decoupling positions to tackle increase or decrease in passenger demand due to an exceptional circumstance. The wait track 206 may be referred to as a minor line. The embodiment (20 to 22) shown in FIGS. 2A to 2C illustrates that coupling events occur between the preceding trains 200_A, 200_B and the following trains 202_A, 202_B and that the preceding trains 200_A, 200_B and the following trains 202_A, 202_B are organized into single groups each running in tandem. However, the embodiment shown in FIGS. 2A to 2C is for convenience of explanation, and the wait track 206 of FIGS. 2A to 2C may be a track for the following train 202_A after decoupling from the preceding train 200_A to wait before coupling with another preceding train 200_B.

As shown in FIG. 2B, the first following train 202_A is coupled with the first preceding train 200_A to form a single group (21). The first following train 202_A starts from the wait track 206 following the determination of the coupling/decoupling position determination apparatus 10 to be coupled with the first preceding train 200_A on the upper track 204_A. The coupling of the first preceding train 200_A and the first following train 202_A increases the train capacity CAP(c, d). This allows a balance to be achieved between the increased passenger demand and the train capacity at the dwell station for the trains after coupling to stop. The train capacity is a numerical value related to the number of passengers that the organized train can accommodate, and it may be calculated by using a preset dispatch schedule. The number of cars included in each of the first preceding train 200_A and the first following train 202_A may be varied according to embodiments. In at least one embodiment, the number of cars included in the first preceding train 200_A may be any one of 4 cars, 6 cars, 8 cars, and 10 cars. The number of cars included in the first following train 202_A is any one of 2 cars, 4 cars, and 6 cars.

As shown in FIG. 2C, the second following train 202_B is coupled with the second preceding train 200_B to form a single group (22). The second following train 202_B starts from the wait track 206 following the determination of the coupling/decoupling position determination apparatus 10 to be coupled with the second preceding train 200_B on the lower track 204_B. The coupling of the second preceding train 200_B and the second following train 202_B increases the train capacity. This can satisfy the increased passenger demand at the dwell station for the trains after coupling to stop. The number of cars included in each of the second preceding train 200_B and the second following train 202_B may be varied according to embodiments. In at least one embodiment, the number of cars included in the second preceding train 200_B is any one of 4 cars, 6 cars, 8 cars, and 10 cars. The number of cars included in the second following train 202_B may be any one of 2 cars, 4 cars, and 6 cars. As illustrated in FIGS. 2A to 2C, based on the coupling and decoupling positions determined by the coupling/decoupling position determination apparatus 10, the preceding trains 200_A, 200_B and the following trains 202_A, 202_B perform coupling or decoupling. Thanks to the coupling of the preceding trains 200_A, 200_B and the following trains 202_A, 202_B, train resources can be efficiently utilized in urban areas or in response to increased passenger demand according to exceptional circumstances. Further, the passengers when using the single group of trains (between 200_A and 202_A or between 200_B and 202_B) are offered improved convenience and improved quality of the train operation service.

Hereinafter, the respective components included in the coupling/decoupling position determination apparatus 10 will be described by referring to FIG. 1.

The data collection unit 100 collects performance data, simulation data, and real-time data from any one of at least one train running on a train route, a dwell station on the train route, and an ATS (Automatic Train Supervision) by using wired or wireless communications. The performance data refers to data on passenger performance, and operation and dispatch performances of the train. The performance data includes passenger performance, operation performance, operation schedule performance, and dispatch schedule performance. The passenger performance includes tag performance which means the accumulated record of passengers entering and exiting the gate of each of the dwell stations located on the train route. The operation performance is about one or more trains passing through a section [s] at a time slot [t] and includes an average passenger occupancy, an average surplus cost, an average shortage cost of the trains, and includes records of trains entering and exiting the platform of each of the dwell stations. The operation schedule performance includes an error between a preset operation schedule and the operation performance of the train. The dispatch schedule performance includes a deviation between a preset dispatch schedule and a dispatch record of the train. Simulation data refers to data on circumstances that are not recorded in the operation and dispatch performances of the train. The simulation data is data calculated by a simulator and includes passenger demand and train operation performance that are not recorded in the performance data. Here, the simulator includes a model which may be an Optimal Trajectory Planning model (OTP). Real-time data is data related to passenger information and train operation information recorded in real-time. The real-time data includes real-time tag data and real-time operation data. The real-time tag data includes information on the number of passengers entering and exiting the gate of the dwell station in real-time and whether the passengers enter or exit the gate. In an embodiment, the real-time tag data is provided as a dataset including a unique ID (user ID) of the transportation card, a toll payment transaction, previous station entry/exit IDs, previous entry/exit times, the current station entry/exit IDs, and the current entry/exit times. The real-time operation data includes information about the location of at least one train operating in real-time on a train route, an arrival time at the dwell station, a departure time from the dwell station, and a driving speed.

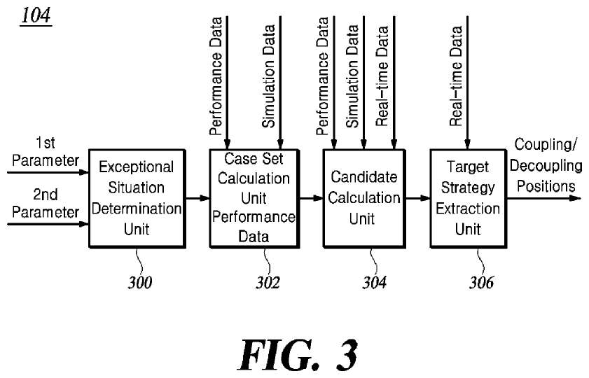

The parameter calculation unit 102 uses at least one of the performance data, simulation data, real-time data, and preset schedule data to calculate and generate a first parameter and a second parameter. The schedule data includes operation and dispatch schedules of the train. The operation schedule includes at least one of an arrival time at dwell station, a departure time from dwell station, a train location, and a driving speed for the train to comply with the dispatch schedule. The dispatch schedule includes information about a dispatch interval for at least one train running on the route and the number of cars in a single group. The first parameter is a parameter for determining whether a train is saturated. The first parameter includes a passenger occupancy (ps(t)), a surplus cost cₛ⁺(t, c, d), and a shortage cost cₛ⁻(t, c, d). The passenger occupancy refers to an estimate of the number of passengers boarding the train passing through operation section [s] in time slot [t]. Here, operation section [s] may be a section [c, d] extending from a coupling position to a decoupling position. The section [c, d] is not limited to a specific dwell station, and may be variously adjusted according to the operation of the present disclosure. The passenger occupancy may be calculated by using real-time tag data, real-time operation data, and schedule data. Specifically, the passenger occupancy may be calculated by accumulating net boarding and alighting quantities for the respective dwell stations. The net boarding and alighting quantity at each dwell station may be estimated by estimating the train that passengers boarded or alighted by using real-time tag data and schedule data. The net boarding and alighting quantity at each dwell station may be verified by comparing the schedule data and real-time operation data and determining which trains passengers actually boarded or alighted. The surplus cost is an indicator of how many more passengers a train can accommodate. The surplus cost is the positive deviation of the passenger occupancy with respect to train capacity CAP(c, d). As described above in FIG. 2B, the train capacity is a numerical value related to the number of passengers that an organized train can accommodate and may be calculated by using a train dispatch schedule. For example, the train capacity may be calculated by multiplying the number of cars included in the train by the number of passengers that one car can accommodate. The shortage cost is an indicator of how much additional capacity a train needs to accommodate passengers. The shortage cost is the negative deviation of the passenger occupancy with respect to the train capacity. The second parameter is a reference value for determining whether the railway traffic condition corresponds to an exceptional situation. The first parameter includes a reference value that may be used in the process of extracting a target strategy. A specific method of extracting the target strategy will be described below with reference to FIG. 3. The second parameter includes an occupancy parameter ΔP₁, ΔP₂, a surplus parameter ΔC₁⁺, ΔC₂⁺, and a shortage parameter ΔC₁⁻, ΔC₂⁻. Here, the occupancy parameter is a reference parameter for determining whether the present railway traffic condition is an exceptional circumstance in terms of train passenger occupancy. The surplus parameter is a reference parameter for determining whether the margin of the train capacity is greater than the average margin in the same time slot. The shortage parameter is a reference parameter for determining whether the shortage of train capacity is greater than the average shortage in the same time slot. The second parameter may be determined by using simulation data and performance data. The value of the second parameter may be variously changed according to a preset exceptional situation determination criterion. Here, as the size of the value of the second parameter is determined, a plurality of data sets related to the second parameter, for example, a first set ΔP₁, ΔC₁⁺, ΔC₂⁺ or a second set ΔP₂, ΔC₂⁺, ΔC₂⁻ may be configured. In at least one embodiment, the parameter included in the first set is a relatively small reference value. When the parameter in the first set is determined to be too small a reference value, coupling and decoupling positions between trains are changed too frequently undesirably. In other words, for insignificant efficiency improvement Δf of train resources by changing the coupling and coupling positions between trains, calculations are repeated undesirably trying to change the coupling and decoupling positions between trains. On the other hand, the parameter included in the second set may be a relatively large reference value. When the parameter in the second set is determined to be a too large reference value, coupling and decoupling positions between trains are hardly changed undesirably. Namely, despite the opportunity for improved efficiency (Δf) of using the train resources by changing the coupling and decoupling positions between trains, cases may arise in which the present situation is not recognized as an exceptional circumstance. Therefore, the data sets of the second parameter need to be configured into a parameter of an appropriate size in consideration of the balance between the improvement of train resource efficiency thanks to the determination of the coupling and decoupling positions and the operation quantity for determining the coupling and decoupling positions.

FIG. 3 is a block diagram for explaining respective components included in the position determination unit 104 according to at least one embodiment.

The position determination unit 104 includes an exceptional situation determination unit 300, a case set calculation unit 302, a candidate group calculation unit (or candidate calculation unit) 304, and a target strategy extraction unit 306 in whole or in part. The position determination unit 104 shown in FIG. 3 is according to at least one embodiment of the present disclosure, and not all blocks shown in FIG. 3 are requisite components, and in some other embodiments, some blocks included in the position determination unit 104 may be added, changed, or deleted. The position determination unit 104 determines coupling and decoupling positions between trains based on the first parameter and the second parameter. The following describes the respective components of the position determination unit 104 for determining the coupling and decoupling positions between trains by referring to FIG. 3.

The exceptional situation determination unit 300 determines, based on the first parameter and the second parameter, whether the present railway traffic condition is an exceptional circumstance. Specifically, when the railway traffic condition meets at least one of a first condition |p̅ₛ̅(t)−pₛ(t)|≥ΔP₁, a second condition |c̅ₛ̅⁺̅ (t)−cₛ⁺(t, c, d)|≥ΔC₁⁺, and a third condition |c̅ₛ̅⁻̅ (t)−cₛ⁻(t, c, d)|≥ΔC₁⁻, the exceptional situation determination unit 300 determines that the present situation is exceptional. Here, the first condition refers to a condition for determining whether the difference between the passenger occupancy of the train and the average passenger occupancy is equal to or greater than the occupancy parameter. The average passenger occupancy means the average of the passenger occupancies of trains that have passed an arbitrary operation section [s] in time slot [t]. The average passenger occupancy may be calculated from the performance data. The second condition refers to a condition for determining whether the difference between the surplus cost for the train and the average surplus cost is equal to or greater than the surplus parameter. The average surplus cost means the average of the surplus costs calculated for a plurality of trains that have passed operation section [s] in time slot [t]. The average surplus cost may be calculated from the performance data. The third condition refers to a condition for determining whether the difference between the shortage cost for the train and the average shortage cost is equal to or greater than the shortage parameter.

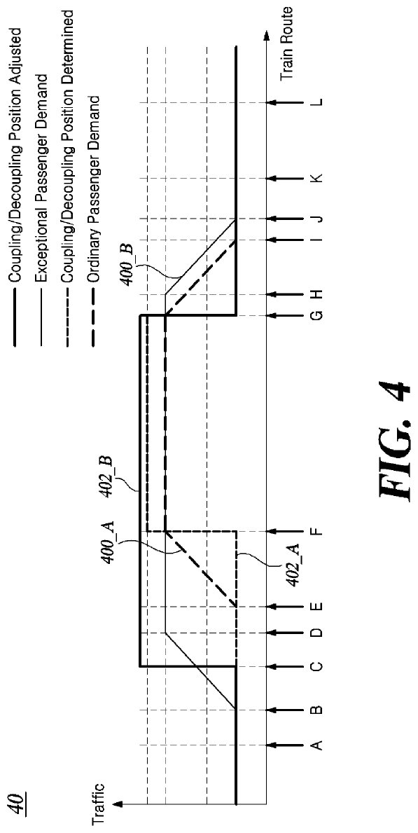

FIG. 4 is a graph illustrating the coupling/decoupling position determination apparatus according to at least one embodiment determining in an embodiment variation (40) the coupling and decoupling positions in response to passenger demand in ordinary or exceptional circumstances.

The embodiment variation (40) shown in FIG. 4 is for convenience of description, and the coupling and decoupling positions determined in response to passenger demand may be varied according to embodiments. The following describes an embodiment in which coupling and decoupling positions are adjusted in response to passenger demand by referring to FIG. 4.

FIG. 4 illustrates an ordinary passenger demand 400_A increasing approaching the urban area (dwell stations E to F) and decreasing toward the suburban area (dwell stations G to I). The coupling/decoupling position determination apparatus 10 determines (at 402_A) the coupling and decoupling positions between trains to tackle the ordinary passenger demand 400_A that increases or decreases depending on the region where the station is located. In at least one embodiment, according to the final coupling and decoupling positions determined by the coupling/decoupling position determination apparatus 10, the coupling is performed between the preceding trains 200_A, 200_B and the following trains 202_A, 202_B at dwell station F. Thereafter, decoupling is performed at dwell station G between the preceding trains 200_A, 200_B and the following trains 202_A, 202_B. The preceding trains 200_A, 200_B and the following trains 202_A, 202_B when performing platooning in section [F, G] can satisfy the ordinary passenger demand 400_A which increases in a specific section. As the following trains 202_A, 202_B are decoupled from the preceding trains 200_A, 200_B at dwell station G, train resources can be efficiently utilized in response to the ordinary passenger demand 400_A which decreases after a specific section. In another embodiment, the coupling and decoupling positions for tackling the ordinary passenger demand may be preset based on the performance data.

FIG. 4 illustrates a section in which an exceptional passenger demand 400_B increases and decreases due to the occurrence of an exceptional circumstance. For example, the exceptional circumstance may be a situation in which an event occurring in the region where the specific dwell station is located in time slot [t] causes passengers to be concentrated at that dwell station. Since the exceptional passenger demand 400_B increases from dwell station B, the coupling/decoupling position determination apparatus 10 calculates a changeable coupling position to tackle the exceptional circumstance. Since the exceptional passenger demand 400_B decreases from dwell station H, the coupling/decoupling position determination apparatus 10 calculates a changeable decoupling position to reduce the surplus cost of the train. Combinations of changeable coupling and decoupling positions may be referred to as position determining cases. For example, the position determining cases in FIG. 4 may be calculated from ₁₂C₂, which is the number of coupling/decoupling position combinations from a given set of 12 dwell stations of dwell station A to dwell station L. In the embodiment of FIG. 4, the number of position determining cases is 66, and a set including the respective position determining cases may be referred to as a case set E(c, d|∪(c, d)ₙ). The case set is calculated by the case set calculation unit 302 included in the coupling/decoupling position determination apparatus 10. In FIG. 4, section [C, G] may be determined as an optimal coupling and decoupling section for tackling an exceptional passenger demand. Since the coupling and decoupling positions are adjusted (at 402_B) from section [F, G] for tackling the ordinary passenger demand to section [C, G] for tackling the exceptional passenger demand (402_6), the coupling/decoupling position determination apparatus 10 according to the present disclosure can meet the increasing and decreasing passenger demands in real-time. The following describes the operations of the case set calculation unit 302, the candidate calculation unit 304, and the target strategy extraction unit 306.

The case set calculation unit 302 is responsive to the exceptional situation determination unit 300 determining the present circumstance to be exceptional, for calculating, based on the performance data and simulation data, the set of cases of determining coupling and decoupling positions of the trains for an arbitrary operation section [s] and for time slot [t] in which the trains pass through operation section [s]. The case set is a set of position determining cases for adjusting the coupling and decoupling positions between trains in response to exceptional circumstances. Here, the position determining case may be a combination of positions for changing from preset coupling and decoupling positions to other coupling and decoupling positions. As described in FIG. 2A, the preceding trains 200_A, 200_B and the following trains 202_A, 202_B tackle ordinary passenger demand by performing coupling and decoupling at preset coupling and decoupling positions. However, when an exceptional circumstance causes the amount of change in the surplus cost or the shortage cost to be larger than the reference value included in the second parameter, there is a need to determine a positional combination of coupling positions and decoupling positions and thereby change the position where the coupling or decoupling is performed between the preceding trains 200_A, 200_B and the following trains 202_A, 202_B. Here, one or more combinations of changeable coupling and decoupling positions to meet passenger demand may be referred to as position determining cases. The case set of position determining cases may be calculated and generated from the simulation data constructed by the simulator.

The candidate calculation unit 304 calculates, based on the case set and performance data, a candidate group (C×D)_{N} for determining the coupling and decoupling positions. The candidate group is a set of candidate cases extracted from the case set. A method performed by the candidate calculation unit 304 for extracting candidate cases will be described. The candidate calculation unit 304 calculates a delay evaluation value f(c, d)ₙ based on a route surplus cost C and a route shortage cost C⁻(c, d)ₙ for all position determining cases included in the case set. The route surplus cost may be calculated by accumulating average surplus costs for section [c, d] based on the average surplus cost included in the performance data. The route shortage cost may be calculated by accumulating the average shortage cost for section [c, d] based on the average shortage cost included in the performance data. The delay evaluation value may be a value w·C⁻(c, d)ₙ+(1−w)·C⁺(c, d)ₙ obtained by adding a calculated first cost weight factor W to the route surplus cost and the route shortage cost, respectively in consideration of the balance between the route surplus cost and the route shortage cost. The first cost weight factor is a real number greater than 0 and less than 1, and the magnitude of the first cost weight factor may be varied according to embodiments of the present disclosure. The candidate calculation unit 304 determines, out of a list of delay evaluation values for all position determining cases, a set of position determining cases for a list of N delay evaluation values taken in ascending order from a minimum delay evaluation value min(f(c, d)ₙ) that is a delay evaluation value having a minimum value, as the candidate group. Unlike the present embodiment, when no candidate group is calculated, the coupling/decoupling position determination apparatus 10 needs to determine optimal coupling/decoupling positions from all of the position determining cases included in the case set. Yet, the candidate calculation unit 304 filters cases other than the position determining cases that are candidates for the target strategy from the case set, thereby providing a significant operation reduction in determining the coupling and decoupling positions.

The target strategy extraction unit 306 calculates a secondary evaluation value f(t, c, d)ₙ for each of the position determining cases belonging to the candidate group by reflecting real-time data. In at least one embodiment, the secondary evaluation value may be a value w′·cₛ⁻(t, c, d)+(1−w′)·cₛ⁺(t, c, d) obtained by adding a calculated second cost weight factor w′ to the surplus cost cₛ⁺(t, c, d) and the shortage cost cₛ⁻(t, c, d) respectively included in the first parameter. The second cost weight factor is a real number greater than 0 and less than 1, and the magnitude of the second cost weight factor may be varied according to embodiments of the present disclosure. The target strategy extraction unit 306 determines, out of a list of secondary evaluation values, a position determining case corresponding to the secondary evaluation value having a minimum value as the final coupling and decoupling positions [c, d]*.

In FIG. 1, the diagram management unit 106 does real-time updating of the train dispatch schedule so that the coupling and decoupling between the trains are performed based on the final coupling and decoupling positions. From the time when the diagram management unit 106 updates the train dispatch schedule, the coupling between the preceding trains 200_A, 200_B and the following trains 202_A, 202_B is performed at the final coupling position [c*]. At the final decoupling position [d*], the decoupling is performed between the preceding trains 200_A, 200_B and the following trains 202_A, 202_B that have been organized as single groups. The updated dispatch schedule is maintained until the position determination unit 104 changes the coupling and decoupling positions between the trains according to a change in passenger demand. The diagram management unit 106 updates the performance data by adding to the same real-time data. The updated dispatch schedule and updated performance data are transmitted to at least one train running on the route and the ATS based on wired or wireless communications.

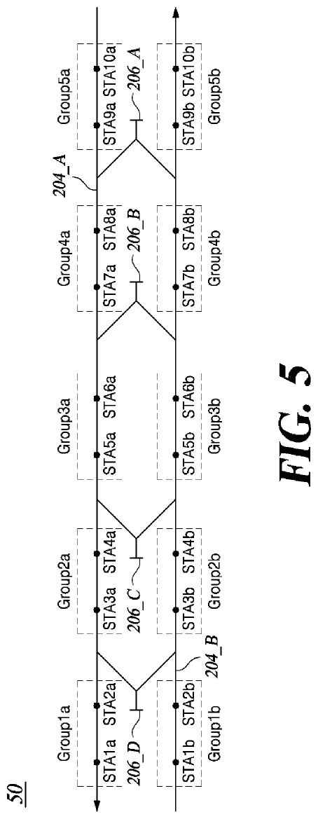

FIG. 5 is a diagram illustrating a grouping of multiple dwell stations existing between coupling and decoupling positions according to an embodiment variation (50).

As shown in FIG. 5, the upper track 204_A has dwell stations of a dwell station 1a (STA1a) to dwell station 10a (STA10a). Dwell stations 1b (STA1b) to 10b (STA10b) are located on the lower track 204_B. A plurality of wait tracks 206_A to 206_D is positioned between the dwell stations. Here, with the positions of the wait tracks 206_A to 206_D as references, the plurality of dwell stations may be simplified into groups. For example, the dwell stations on the upper track 204_A may each be simplified to belong to any one of group 1a (STA1a and STA2a) to group 5a (STA9a and STA10a). The dwell stations on the lower track 204_B may each be simplified to belong to any one of group 1b (STA1b and STA2b) to group 5b (STA9b and STA10b). By grouping the dwell stations based on the positions of the wait tracks 206_A to 206_D, the changing passenger demand in each dwell station section may also be grouped. This can effect an operation reduction of the coupling/decoupling position determination apparatus 10 in determining the coupling and decoupling positions between trains.

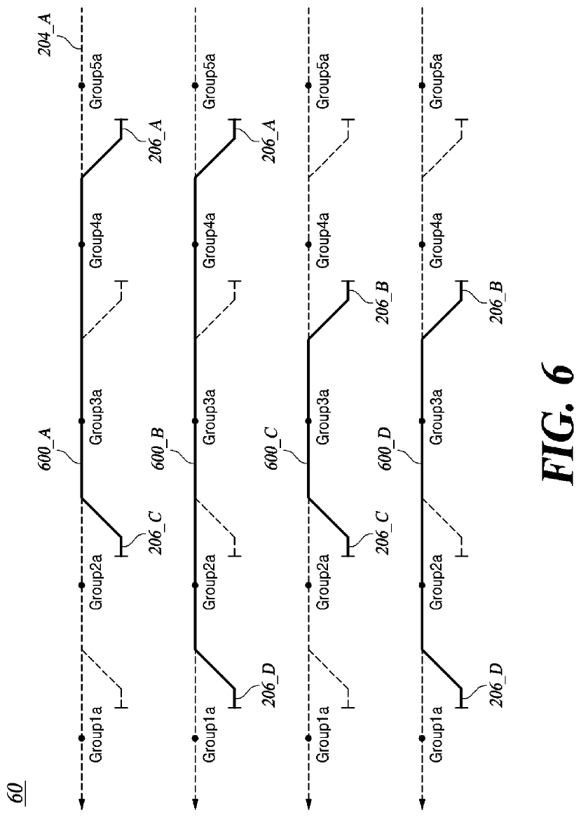

FIG. 6 is a diagram illustrating cases of performing coupling and decoupling by the operation of the coupling/decoupling position determination apparatus 10 according to some embodiment variations (60).

The following describes embodiment variations (60) in which the first preceding train 200_A and the first following train 202_A run along coupling and decoupling routes 600 (600_A to 600_D) based on combinations [c, d]* of the final coupling and decoupling positions determined by the coupling/decoupling position determination apparatus 10 of the present disclosure by referring to FIG. 6.

In at least one embodiment, after departing the first wait track 206_A, the first preceding train 200_A performs coupling with the first following train 202_A and passes through a dwell station belonging to group 3a to group 4a (600_A). The first preceding train 200_A and the first following train 202_A perform decoupling at the last dwell station of group 3a. The first following train 202_A enters the third wait track 206_C and waits until it receives a command to couple with another preceding train.

In another embodiment, after departing the first wait track 206_A, the first preceding train 200_A performs coupling with the first following train 202_A and passes through a dwell station belonging to group 2a to group 4a (600_B). The first preceding train 200_A and the first following train 202_A perform decoupling at the last dwell station of group 2a. The first following train 202_A enters the fourth wait track 206_D and waits until it receives a command to couple with another preceding train.

In yet another embodiment, after departing the second wait track 206_B, the first preceding train 200_A performs coupling with the first following train 202_A and passes through a dwell station belonging to group 3a (600_C). The first preceding train 200_A and the first following train 202_A perform decoupling at the last dwell station of group 3a. The first following train 202_A enters the third wait track 206_C and waits until it receives a command to couple with another preceding train.

In yet another embodiment, after departing the second wait track 206_B, the first preceding train 200_A performs coupling with the first following train 202_A and passes through a dwell station belonging to group 2a to group 3a (600_D). The first preceding train 200_A and the first following train 202_A perform decoupling at the last dwell station of group 2a. The first following train 202_A enters the fourth wait track 206_D and waits until it receives a command to couple with another preceding train.

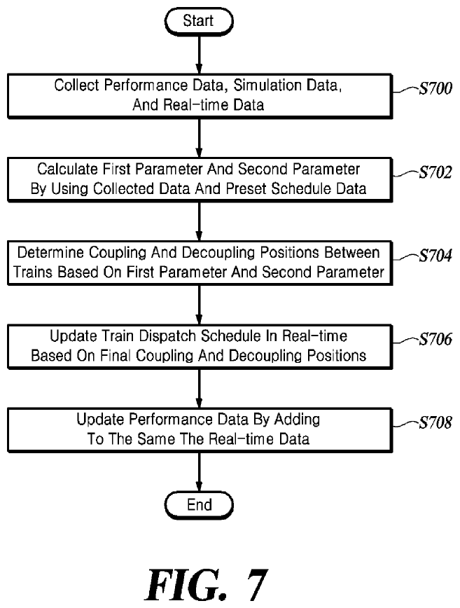

FIG. 7 is a flowchart of a method of determining coupling and decoupling positions according to at least one embodiment.

The following describes the respective steps included in the method of determining the coupling and decoupling positions by referring to FIG. 7. A repeat description of those presented by FIGS. 1 to 6 is omitted.

The data collection unit 100 collects, from one or more trains running on a train line, dwell stations on the train line, and an ATS, performance data, simulation data, and real-time data by using wired or wireless communications (S700). Specific data included in performance data, simulation data, and real-time data have been described in detail in FIG. 1, and hence reiterative details thereof will be omitted.

The parameter calculation unit 102 calculates a first parameter and a second parameter by using at least one of the performance data, simulation data, real-time data, and preset schedule data (S702). The parameters included in the first parameter may each be calculated based on the net alighting quantity for each dwell station calculated by using the method described with reference to FIG. 1 and the train capacity calculated by using the dispatch schedule. The second parameter may be calculated as a threshold value for determining an exceptional circumstance by using simulation data and performance data. In another embodiment, the second parameter may be a set of parameters that are preset based on the performance data. Here, the position determination unit 104 may call out and compare a preset second parameter with real-time data to determine whether the present situation is an exceptional circumstance.

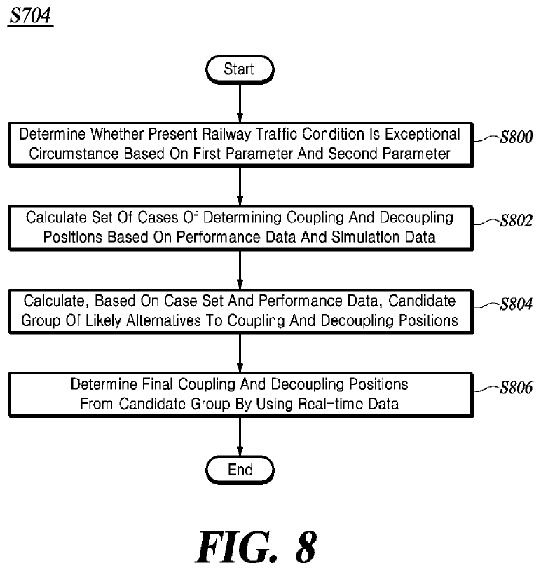

The position determination unit 104 determines the coupling and decoupling positions between the trains based on the first parameter and the second parameter (S704). The position determining step S704 has substeps which will be described respectively below by referring to FIG. 8.

The diagram management unit 106 updates the dispatch schedule of the train in real-time so that the coupling and decoupling between the trains are performed based on the final coupling and decoupling positions (S706). The trains on a train route subject to the updated dispatch schedule perform coupling or decoupling with other trains at the coupling and decoupling positions determined by the position determination unit 104. The preceding and following trains join into platooning, which can tackle changing passenger demand in real-time.

The diagram management unit 106 updates the performance data by adding to the same real-time data (S708). The performance data is updated as the number of train operations is accumulated by the operation of the diagram management unit 106. With a machine learning model for determining the platooning section, which is trained by using the performance data, the accuracy of the platooning section calculated in response to real-time passenger demand can be significantly increased.

FIG. 8 is a flowchart of the position determining step S704 included in the method of determining coupling and decoupling positions according to at least one embodiment.

Hereinafter, the respective substeps in the position determining step S704 will be described by referring to FIG. 8.

The exceptional situation determination unit 300 determines whether the present railway traffic condition is an exceptional circumstance based on the first parameter and the second parameter (S800). Since the condition used by the exceptional situation determination unit 300 to detect the exceptional circumstance has been described in FIG. 3, and hence reiterative details thereof will be omitted.

The case set calculation unit 302 is responsive to the exceptional situation determination unit 300 determining the present situation to be exceptional, for calculating, based on performance data and simulation data, the set of cases of determining the coupling and decoupling positions of the trains for operation section [s] and for time slot [t] in which the trains pass through operation section [s] (S802). The case set has been described in FIG. 3, and hence reiterative details thereof will be omitted.

The candidate calculation unit 304 calculates a candidate group of the likely alternatives to the coupling and decoupling positions based on the case set and performance data (S804). The candidate group has been described in detail in FIG. 3, and hence reiterative details thereof will be omitted.

The target strategy extraction unit 306 determines the final coupling and decoupling positions from the candidate group by using real-time data (S806). The determination of the final coupling and decoupling positions has been described in FIG. 3, and hence reiterative details thereof will be omitted.

The present disclosure according to at least one embodiment determines a section where to perform platooning of multiple trains based on a traffic pattern calculated by using passenger data, thereby allowing efficient utilization of the resources of trains in groups.

The present disclosure according to another embodiment detects particular cases involving an exceptional circumstance or exceptional changes in the traffic pattern and accordingly determines the coupling and decoupling positions between the trains, thereby allowing responsive utilization of the train resources to tackle varying passenger demand in real-time.

### Second Embodiment

The second embodiment in one aspect provides a technology responsive to an exceptional circumstance involving a train deviation from the joint schedule for determining the coupling position between the preceding train and the following train for recovery of platooning therebetween.

The second embodiment in another aspect provides technology for determining the coupling position between the preceding train and the following train for allowing the two trains to be coupled on a track toward increasing the efficiency of using the track.

The second embodiment provides a technique for determining a coupling position between trains to recover platooning. In particular, the second embodiment provides a coupling position determining apparatus for calculating, with respect to a joint station, delay estimation values of a planned preceding train and a planned following train on the same operation schedule, respectively. The coupling position determining apparatus compares the calculated delay estimation values respectively with a preset threshold value. The coupling position determining apparatus determines whether coupling between trains can be performed at the joint station in compliance with the operation schedule. In particular, to implement the planned train platooning to begin at the joint station, the coupling position determining apparatus determines whether the present railway traffic condition is an exceptional circumstance involving an additional delay. Upon determining it is the exceptional circumstance, the coupling position determining apparatus determines the coupling position for allowing coupling between trains to be performed not at the joint station but at another dwell station or in an inter-station route. With the trains coupled adaptively at the determined coupling position, platooning delayed due to the exceptional circumstance is restored. In short, the coupling position determining apparatus is responsive to a failed implementation of platooning due to an exceptional circumstance for determining the coupling position between trains for recovering the platooning. Therefore, the coupling position determining technology according to the present disclosure reduces train operation delays and increases the efficiency of the use of the track.

In the second embodiment, coupling refers to a state in which a distance is maintained within a certain range between a preceding train and the following train when running on a track. For example, the preceding train transmits and receives information to and from an ATS (Automatic Train Supervision) or the following train based on V2V (Vehicle-to-Vehicle) or V2I (Vehicle-to-Infrastructure) communications. The preceding train may be organized as a single group with the following train based on the information transmitted/received to and from the ATS or the following train. Accordingly, in the second embodiment, the coupling does not necessarily mean a physical coupling formed between trains by using mechanical devices but may be a logical coupling based on wireless communications. In the second embodiment, coupling between trains may be implemented by using a train-sets control technique for virtual coupling as known in the art.

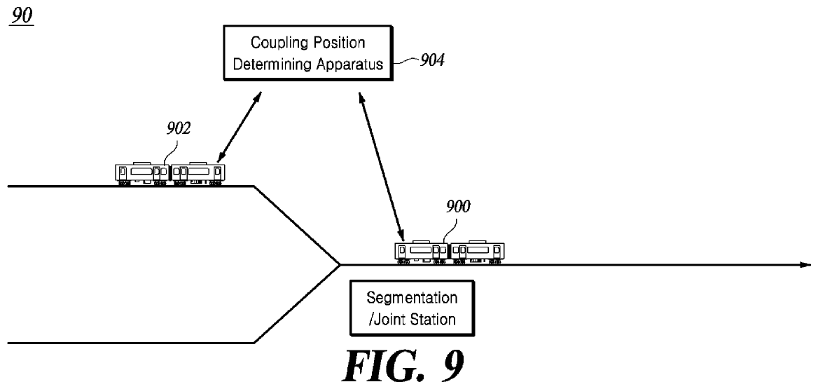

In the second embodiment, the first train refers to a train that is planned to enter the joint station first and wait for coupling with the second train according to a preset operation schedule. In the second embodiment, the second train refers to a train planned to follow the first train into the joint station and perform coupling with the first train according to the preset operation schedule. In the second embodiment, the joint station refers to a dwell station serving as a reference for multiple diverging tracks when converged into at least one track. The joint station becomes a reference dwell station for multiple trains running in the opposite direction to the converging direction to diverge from each other, which makes it referred to as a segmentation station. Multiple trains each running on multiple diverging tracks begin at the joint station to travel on at least one or more converging tracks. FIGS. 9, 10A, 10B, 10C, 11A, 11B, 13A, 13B, 14A, 14B, 15A, and 15B illustrate a track configuration according to one of the embodiments of the present disclosure, which may vary in terms of the number of diverging tracks and/or the number of converging tracks according to various traffic environments in which the second embodiment is implemented.

In the second embodiment, the first railway means a diverging track on which the first train runs before entering the joint station. In the second embodiment, the second railway means a diverging track on which the second train runs before entering the joint station. In the second embodiment, when the first train and the second train enter the joint station from different tracks, the first railway and the second railway may represent different tracks. In another embodiment, when the first train and the second train enter the joint station from the same track, the first railway and the second railway may represent the same track.

In the second embodiment, an operation delay value of a train means a value obtained by subtracting a scheduled arrival time that is set for the train to arrive at the joint station on schedule from a joint-station arrival time that is recorded as the actual train operation performance. For example, the operation delay value of the first train means a value obtained by subtracting the scheduled arrival time for the first train to arrive at the joint station on the operation schedule from the joint-station arrival time recorded through the actual operation of the first train. The operation delay of the following train means the value obtained by subtracting the scheduled arrival time for the following train to arrive at the joint station on the operation schedule from the joint-station arrival time recorded through the actual operation of the following train.

In the second embodiment, the preceding train means a train seen as actually operating to enter the joint station first and wait for coupling with the following train. In the second embodiment, the following train means a train seen as actually operating to follow the preceding train to enter the joint station. For example, in the second embodiment, between the first train and the second train traveling in an actual train operation environment and entering the joint station, the train that enters the joint station first is referred to as the preceding train. In the second embodiment, when the first train arrives at the joint station before the second train to meet the preset operation schedule, the first train is referred to as the preceding train. Here, when the second train arrives at the joint station later than the first train, the second train is referred to as the following train. In another embodiment, when the first train arrives at the joint station later than the second train against the preset operation schedule, the first train is referred to as the following train. Here, when the second train arrives at the joint station before the first train, the second train is referred to as a preceding train. In yet another embodiment, a train running on the same route as the diverging route on which the preceding train runs before entering the joint station may be referred to as an identical-railway train. Here, the identical-railway train when entering the joint station following the preceding train is referred to as the following train. In the second embodiment, the preceding train departs from the platform first without waiting for the following train to avoid additional delay. Accordingly, the following train performs coupling with the preceding train at another dwell station or in an inter-station route to perform platooning.

In the second embodiment, a preset scheduled coupling time \tilde{t}₀ means a pre-planned time at which the preceding train and the following train start to intercouple at joint station [so] and perform platooning.

In the second embodiment, a coupling management initiation time \tilde{t}ₛₜₐᵣₜ means a time at which the present disclosure starts to classify the present railway traffic condition as a normal circumstance or an exceptional circumstance in preparation for the occurrence of an exceptional circumstance. In particular, to determine whether there is a need for determining the coupling position to perform a delayed coupling, the coupling position determining apparatus according to the second embodiment monitors the present situation from the coupling management initiation time. The coupling management initiation time may be varied according to embodiments of the present disclosure.

In the second embodiment, a coupling management termination time \tilde{t}_{end} refers to the time at which the present disclosure terminates the monitoring of the present railway traffic condition. When it is determined that the coupling of trains at the joint station is to be performed according to the operation schedule ruling out an exceptional circumstance, the monitoring of the railway traffic condition is terminated. The coupling management termination time may be varied according to embodiments of the present disclosure. For a coupling management duration [\tilde{t}ₛₜₐᵣₜ, \tilde{t}_{end}], a determination is made on the need for a delayed coupling, and the monitoring of the railway traffic condition is carried out for a predetermined time before each pair of coupling trains enters the joint station.

FIG. 9 is a conceptual diagram for explaining components included in a coupling position determining system 90 according to the second embodiment of the present disclosure.

The coupling position determining system 90 according to the second embodiment includes a preceding train 900, a following train 902, and a coupling position determining apparatus 904 in whole or in part.

The coupling position determining apparatus 904 determines in advance whether the waiting time of the preceding train 900 at the joint station is greater than or equal to a preset threshold to perform the coupling between the preceding train 900 and the following train 902. In the second embodiment, the coupling position determining apparatus 904 is configured as part of an automatic train supervision (ATS) system on the ground. Here, the coupling position determining apparatus 904 may use V2I-based wireless communications for transmitting and receiving information with one or more trains running on a train route. The information transmitted/received between the coupling position determining apparatus 904 and the trains may include real-time operation data that is data about the current position of at least one train. In other embodiments, the coupling position determining apparatus 904 is included as part of an onboard apparatus. When the coupling position determining apparatus 904 is included in at least one of the trains 900 and 902 running on the train route, the coupling position determining apparatus 904 may transmit/receive information with the ATS or other train by using V2I or V2V-based wireless communications. Here, the information transmitted/received between the coupling position determining apparatus 904 and the ATS or the information transmitted/received between the coupling position determining apparatus 904 and another train may include real-time operation data that is data about the current location of at least one train.

The preceding train 900 departs first without waiting for the following train 902 when it predicts that an additional delay due to waiting is equal to or greater than a preset threshold. Here, the time at which the preceding train 900 departs is calculated by the coupling position determining apparatus 904.

The following train 902 performs coupling with the preceding train 900 at another dwell station or in an inter-station route based on the newly determined coupling position. Here, the coupling position between the preceding train 900 and the following train 902 is determined by the coupling position determining apparatus 904.

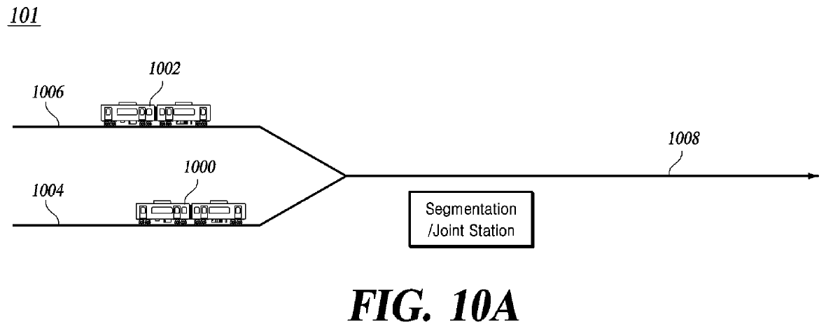

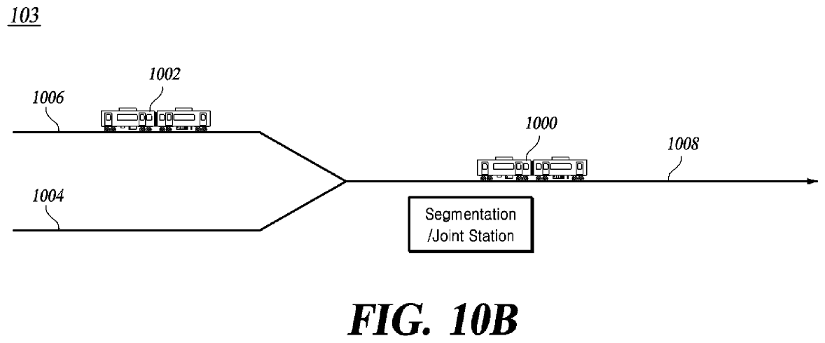

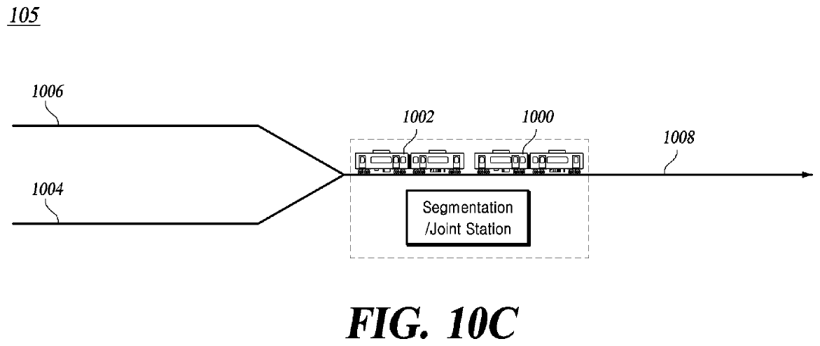

FIGS. 10A to 10C illustrate a coupling position determining method according to the second embodiment by an embodiment variation (101-103-105) wherein a first train 1000 waits until a second train 1002 enters a joint station, when and where the first train 1000 performs coupling with the second train 1002.

As shown in FIG. 10A, the first train 1000 is running on the first railway 1004. The second train 1002 is running on a second railway. The first train 1000 and the second train 1002 are planned to perform coupling at the joint station and then perform platooning on a joint track 1008. As shown in FIG. 10B, the first train 1000 enters the joint station before the second train 1002 and waits at the platform of the joint station for coupling with the second train 1002. The first train 1000 may be referred to as the preceding train 900 from a point in time when it enters the joint station earlier than the second train 1002 to meet the operation schedule. Since the second train 1002 will enter the joint station later than the first train 1000, the second train may be referred to as the following train 902. However, when the operation of the second train 1002 is delayed due to the occurrence of an exceptional circumstance, the coupling between the first train 1000 and the second train 1002 cannot be performed to meet the operation schedule. Here, the factors for the occurrence of the exceptional circumstance include, for example, a breakdown of the second train, damage to the second railway, and sudden bad weather. When the first train 1000 waits to perform coupling with the second train 1002 at the joint station despite the delay in operation of the second train 1002, the first train 1000 gets further behind operation schedule. As shown in FIG. 10C, the second train 1002 resolves the cause of the exceptional circumstance and enters the joint station. After the first train 1000 and the second train 1002 intercouple at the platform of the joint station, they depart from the joint station and perform platooning. However, since the first train 1000 waits until the second train 1002 enters the joint station, at least one following train suffers an undesirable chain operation delay.

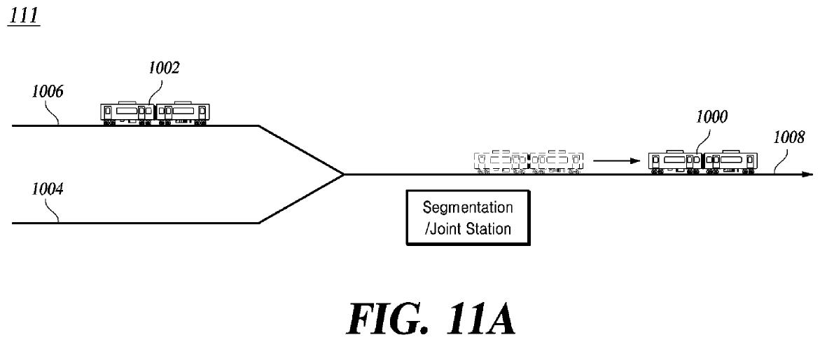

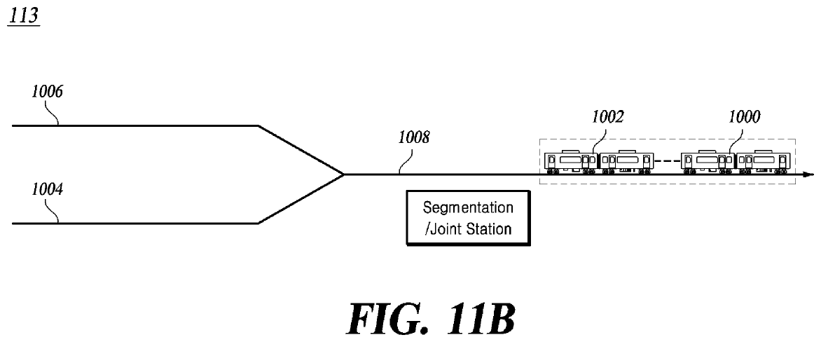

FIGS. 11A and 11B illustrate a coupling position determining method according to the second embodiment by an embodiment variation (111 and 113) wherein the first train 1000 departs first without waiting for the second train 1002 and thereafter performs coupling with the second train 1002 at a coupling position calculated according to the present disclosure.

As shown in FIG. 11A, with a failed platooning between the first train 1000 and the second train 1002 at the joint station, the first train 1000 stops waiting and departs from the joint station first. The coupling position determining apparatus 904 according to the second embodiment determines a time point at which the first train 1000 departs from the joint station to solve a chain operation delay due to the occurrence of an exceptional circumstance. As shown in FIG. 11B, the first train 1000 performs coupling with the second train 1002 at the newly determined coupling position, thereby restoring platooning. Here, the newly determined coupling position includes another dwell station or an inter-station route on the joint track 1008. The coupling position determining apparatus 904 determines a coupling position for recovering platooning between the first train 1000 and the second train 1002.

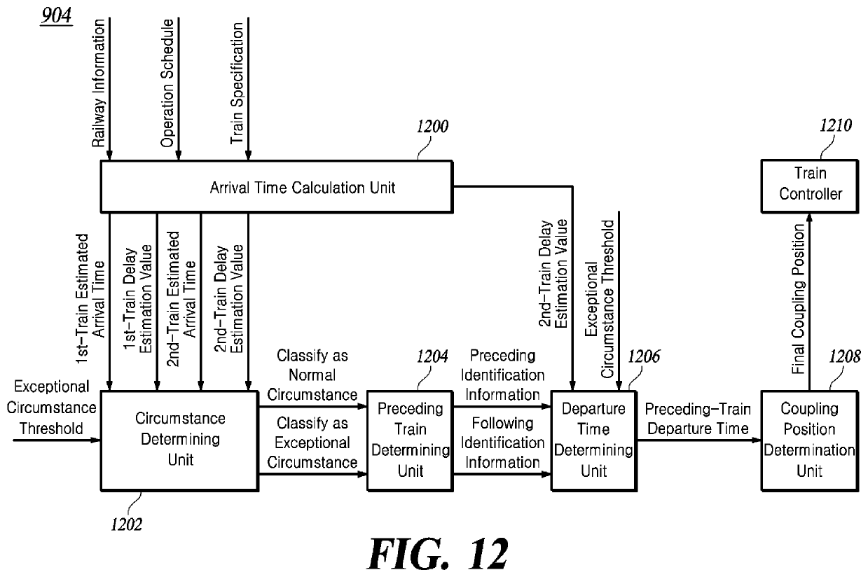

FIG. 12 is a block diagram of components included in the coupling position determining apparatus 904 according to the second embodiment of the present disclosure.

The coupling position determining apparatus 904 according to the second embodiment includes an arrival time calculation unit 1200, a circumstance determining unit 1202, a preceding train determining unit 1204, a departure time determining unit 1206, a coupling position determining unit 1208, and a train controller 1210 in whole or in part. The coupling position determining apparatus 904 shown in FIG. 12 is according to the second embodiment of the present disclosure, and not all blocks shown in FIG. 12 are requisite components, and in other embodiments, the coupling position determining apparatus 904 has some component blocks added, changed, or deleted.

The following describes the respective components of the coupling position determining apparatus 904 by referring to FIG. 12.

The arrival time calculation unit 1200 calculates and generates real-time estimation data about one or more trains by using pre-stored simulation input data. Here, the real-time estimation data includes an estimated arrival time of the train and a delay estimation value. The estimated arrival time means the estimated time that the train will arrive at the joint station. Specifically, the arrival time calculation unit 1200 obtains, from the coupling management initiation time, real-time location x₁(t) of the first train and real-time location x₂(t) of the second train based on the wireless communications with the ATS or other trains. The arrival time calculation unit 1200 calls out pre-stored simulation input data necessary for the simulation with respect to the sections extending from the respective real-time locations (x₁(t) and x₂(t)) of the trains to the dwell station. Here, the simulation input data includes railway information IFR, a train operation schedule SCH, and a train specification RS. The train specification includes the load, acceleration force, and deceleration force of the train. The arrival time calculation unit 1200 calls out a pre-learned simulator to perform the simulation. Here, the execution condition of the simulator is preset to ‘All-Out Mode’. The simulation model included in the simulator may be an Optimal Trajectory Planning (OTP) model. The arrival time calculation unit 1200 inputs the simulation input data to the simulator to output delay estimation values \dot{δ}ₛ_{₀} of the first train 1000 and the second train 1002. Here, the delay estimation value means the delay time of the estimated arrival time \dot{a}ₛ_{₀} at which the train is expected to arrive at the joint station [s₀] compared to an arrival time ãₛ_{₀} on the operation schedule. For example, a first delay estimation value \dot{δ}ₛ_{₀}_{,1}, which means the delay estimation value for the first train 1000, is a value that equals to a first estimated arrival time \dot{a}ₛ_{₀}_{,1} at which the first train 1000 is determined to arrive at the joint station minus an arrival time ãₛ_{₀}_{,1} at the joint station on the operation schedule. A second delay estimation value \dot{δ}ₛ_{₀}_{,2}, which means the delay estimation value for the second train 1002, is a value that equals a second estimated arrival time \dot{a}ₛ_{₀}_{,2} at which the second train 1002 is determined to arrive at the joint station minus an arrival time ãₛ_{₀}_{,2} at the joint station on the operation schedule.

The circumstance determining unit 1202 compares the respective real-time locations of the first train 1000 and the second train 1002 with those on the preset train operation schedule to classify the present railway traffic condition as a normal circumstance or an exceptional circumstance.

In the second embodiment, normal circumstance n means a situation in which the coupling can be performed on operation schedule between the first train 1000 and the second train 1002. Under normal circumstances, the first train 1000 enters the platform of the joint station before the second train 1002. Under normal circumstances, although the second train 1002 enters the platform of the joint station later than the first train 1000, the first train 1000 can proceed without further delay to join and perform platooning with the second train 1002 at the joint station. Under normal circumstances, the first train 1000 may be referred to as the preceding train 900, and the second train 1002 as the succeeding train 902. Meanwhile, a first parameter set L, F, δ_{L}(t), δ_{F}(t) is used in a normal circumstance and includes preceding identification information L, following identification information F, a real-time preceding delay δ_{L}(t), and a real-time following delay δ_{F}(t). Here, preceding identification information L means a unique identifier capable of distinguishing the preceding train 900. Following identification information F means a unique identifier capable of distinguishing the following train 902. Real-time advance delay δ_{L}(t) means a delayed time compared to the operation schedule as a result of actually operating the preceding train 900 in a specific time slot [t]. Real-time following delay δ_{F}(t) means a delayed time compared to the operation schedule as a result of actually operating the following train 902 in a specific time slot [t].

In the second embodiment, an exceptional circumstance e means an expected situation where the following train 902 is delayed to require the preceding train 900, which arrived at the joint station first, to wait at the platform of the joint station for a preset wait time or longer before performing platooning.

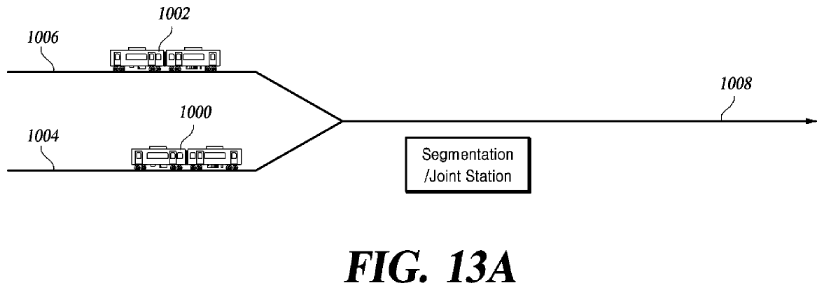

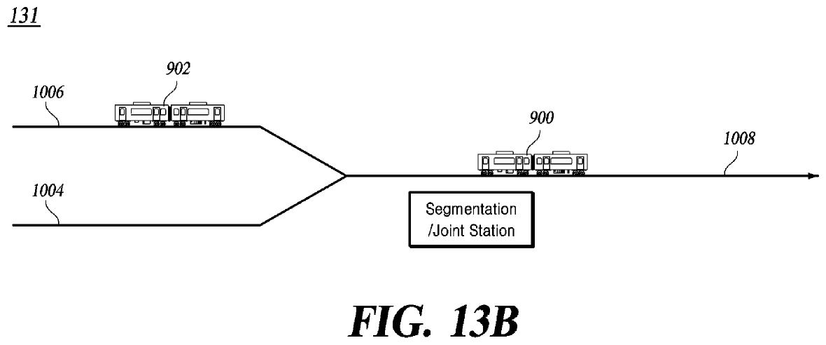

FIGS. 13A and 13B illustrate a first exceptional circumstance (131) which is an operating condition of the coupling position determining method according to at least one embodiment.

FIG. 13A illustrates the first train 1000 entering the joint station before the second train 1002, when the preset operation schedule is satisfied for the first train 1000. Here, the first train 1000 that entered the joint station first may be referred to as the preceding train 900. The second train 1002 that enters the joint station later than the preceding train 900 may be referred to as the following train 902. FIG. 13B illustrates a delayed operation of the following train 902, requiring the preceding train 900 to wait infinitely for the following train 902 to join at the platform of the joint station. A predicted situation as in FIG. 13B may be classified as the first exceptional circumstance (131) if it would further delay the preceding train 900 to perform coupling with the following train 902 at the joint station.

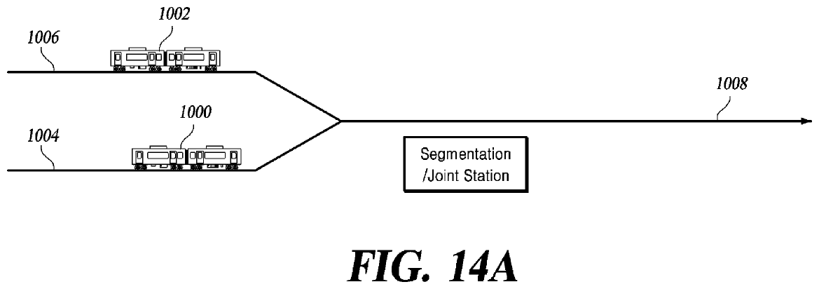

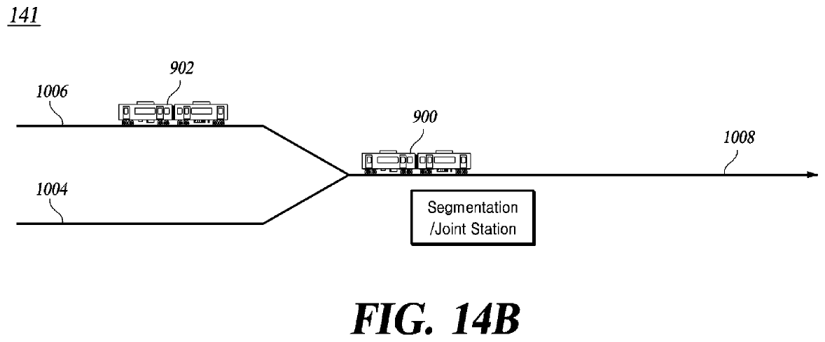

FIGS. 14A and 14B illustrate a second exceptional circumstance (141) which is an operating condition of the coupling position determining method according to the second embodiment.

FIG. 14A illustrates the first train 1000 entering the joint station before the second train 1002 but arriving at the platform of the joint station at a time delayed from the operation schedule. Here, the first train 1000 that entered the joint station first may be referred to as the preceding train 900. The second train 1002 that enters the joint station later than the preceding train 900 may be referred to as the following train 902. FIG. 14B illustrates delayed operations of both the preceding train 900 and the following train 902, resulting in an additional delay occurred in the implementation of platooning between the trains at the joint station. A predicted situation as in FIG. 14B may be classified as the second exceptional circumstance (141) if both the preceding train 900 and the following train 902 would arrive at the platform of the joint station at a time delayed from the operation schedule to incur a delay greater than or equal to a preset threshold.

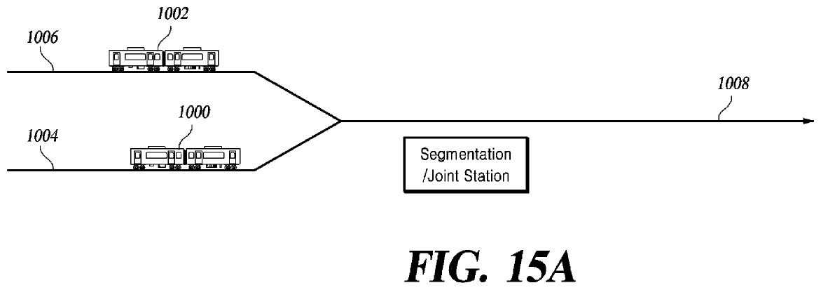

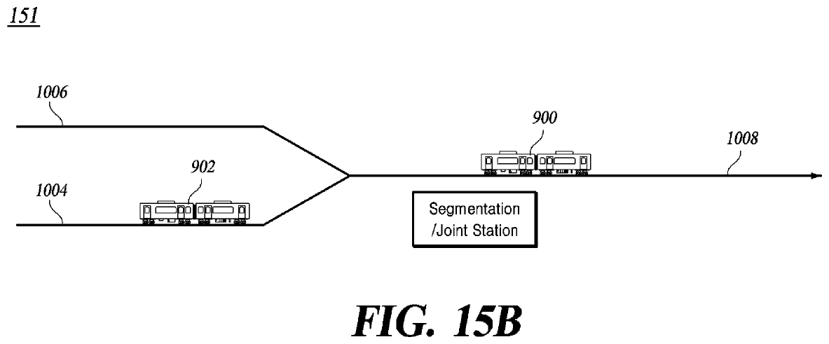

FIGS. 15A and 15B illustrate a third exceptional circumstance (151) which is an operating condition of the coupling position determining method according to the second embodiment.

FIG. 15A illustrates a delay to occur in the first train 1000, making the same to enter the joint station later than the second train 1002 does. Here, since the second train 1002 enters the joint station before the first train 1000, the second train 1002 may be referred to as the preceding train 900. Since the first train 1000 enters the joint station later than the second train 1002, the first train 1000 may be referred to as the following train 902. A predicted situation as in FIG. 15B may be referred to as the third exceptional circumstance (151) if the first train 1000 would arrive at the platform of the joint station later than the second train 1002 to incur a delay in coupling between the trains.

The coupling position determining apparatus 904 shown in FIG. 12 in an exceptional circumstance utilizes a second parameter set L, F, δ_{L}(s), δ_{F}(s), T₀, T₁, T₂ that includes preceding identification information L, following identification information F, a predicted preceding delay δ_{L}(s), a predicted following delay δ_{F}(s), a following delay threshold T₀, an arrival deviation threshold T₁, and a preceding waiting threshold Ti Here, predicted preceding delay δ_{L}(S) is a value of delay predicted, by which the preceding train 900 is determined to be behind the operation schedule when it would enter dwell station [s]. The preceding delay is predicted at a time point tₑ at which the situation determination unit 1202 determines that the present circumstance is an exceptional circumstance. Predicted following delay δ_{F}(s) is a value of delay predicted, by which the following train 902 is determined to be behind the operation schedule when it would enter an arbitrary dwell station [s] located on the train route. The following delay is predicted at time point tₑ at which the situation determination unit 1202 determines that the present circumstance is an exceptional circumstance. Following delay threshold T₀ is precalculated by the simulator and means a threshold value for the delay limit of the following train 902. Arrival deviation threshold T₁ is precalculated by the simulator and means a threshold value for the difference between the arrival time of the preceding train 900 at the dwell station and the arrival time of the following train 902 at the joint station. Preceding waiting threshold T₂ is precalculated by the simulator and means a threshold value regarding the limit of the waiting time for the preceding train 900 to couple with the following train 902.

The circumstance determining unit 1202 may classify the present railway traffic condition as an exceptional circumstance when the first train 1000 or the second train 1002 is in a traffic condition that meets at least one of the first condition, the second condition, and the third condition. The first condition means that the second delay estimation value \dot{δ}ₛ_{₀}_{,2} is equal to or greater than the following delay threshold T₀. The second condition means that the first delay estimation value \dot{δ}ₛ_{₀}_{,1} is equal to or greater than the following delay threshold T₀. For example, the circumstance determining unit 1202 may classify the present situation as an exceptional circumstance when the predicted delay time of the first train 1000 or the second train 1002 is predicted to be equal to or greater than the following delay threshold T₀. The third condition means that the difference between the first estimated arrival time \dot{a}ₛ_{₀}_{,1} for the first train 1000 and the second estimated arrival time \dot{a}ₛ_{₀}_{,2} for the second train 1002 is equal to or greater than the arrival deviation threshold T₁. For example, the circumstance determining unit 1202 may classify the present situation as an exceptional circumstance when the difference between the respective arrival times of the first train 1000 and the second train 1002 at the joint station is predicted to be equal to or greater than the arrival deviation threshold T₁.

The preceding train determination unit 1204 is responsive to the present-circumstance determining unit 1202 classifying the present situation as an exceptional circumstance for comparing the estimated arrival times of the first train 1000 and the second train 1002 and determining that the train predicted to enter the joint station first is the preceding train 900. For example, when it is predicted that the first train 1000 will enter the joint station first, the preceding train determining unit 1204 determines that the first train 1000 is the preceding train 900 corresponding to the leading end of the coupling. On the other hand, if it is predicted that the second train 1002 will enter the joint station first, the preceding train determining unit 1204 determines that the second train 1002 is the preceding train 900 corresponding to the leading end of the coupling. Specifically, the preceding train determining unit 1204 may determine the unique identifier of the train determined to be the preceding train 900, as preceding identification information L. The preceding train determining unit 1204 may determine the unique identifier of the train determined to be the following train 1002 as following identification information F.

The departure time determining unit 1206 determines the time when the delay estimation value for the following train 902 is equal to or greater than the preceding waiting threshold as the preceding-train departure time. The preceding train 900 receives the preceding-train departure time from the coupling position determining apparatus 904, and when it is the preceding-train departure time, the preceding train 900 no longer waits for the following train 902 and departs from the joint station.

The coupling position determination unit 1208 determines a coupling position [x*_{LF}] at which the platooning starts between the preceding train 900 and the following train 902 based on the preceding-train departure time. Specifically, the coupling position determination unit 1208 determines a temporary coupling position between the preceding train 900 and the following train 902 and determines the final coupling position [x*_{LF}] depending on whether the temporary coupling position is included in the area of another dwell station. Here, another dwell station is one of multiple dwell stations located on the service route, and it means a dwell station at which the preceding train 900 and the following train 902 stop after the joint station. The area of the dwell station means an area within a predetermined distance from the platform of the dwell station. The coupling position determining unit 1208 determines the driving speed of the following train for recovering the platooning. The coupling position determining unit 1208 utilizes the maximum train performance information max(RS) reflected in the operation schedule to determine the driving speed of the following train. The coupling position determining unit 1208 calculates the driving speed of the following train by using the simulator. The following train 902 receives the driving speed for coupling from the coupling position determining apparatus 904 based on wireless communications and runs on the joint track 1008 according to the driving speed to perform coupling with the preceding train 900. Here, the driving speed of the following train means the average driving speed of the following train as measured by taking into account the acceleration or deceleration of the following train 902 to stop at respective dwell stations.

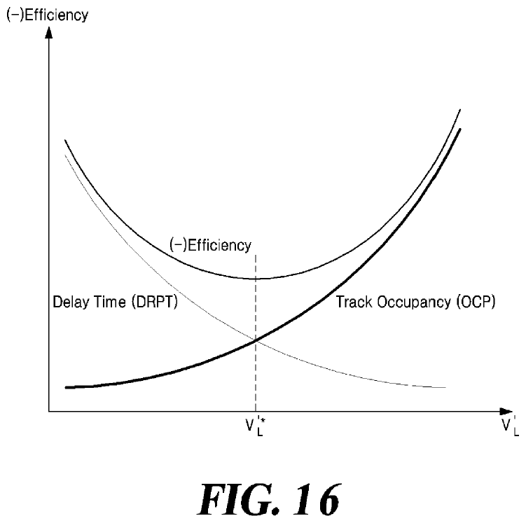

FIG. 16 illustrates a method of calculating an optimal driving speed of the preceding train to determine the coupling position in the coupling position determining method according to the second embodiment of the present disclosure.

FIG. 16 shows the (−)efficiency of track use by trains according to a driving speed v′_{L} of the preceding train. The (−)efficiency by trains may be calculated by adding a total chain delay time DRPT and a track occupancy time OCP of the preceding train 900 and the following train 902. As can be seen from FIG. 16, the total chain delay time of the trains tends to decrease as the driving speed of the preceding train increases. The track occupancy time of the trains tends to increase as the driving speed of the preceding train increases. Accordingly, the coupling position determining unit 1208 calculates an optimal driving speed v′*_{L} of the preceding train such that the sum of the total chain delay time and the track occupancy time is minimized, based on Equation 1 below.

$$min ( Z ) = {\sum }_{s ∈ S ( {s}_{0} )} {\sum }_{i ∈ J ( L , F )} DRPT ( s , i ) + α \cdot {\sum }_{t ∈ T} {OCP}_{L + F} ( t ) \qquad Equation 1$$

The coupling position determining unit 1208 calculates the optimal driving speed of the preceding train so that the sum of total chain delay time DRPT and track occupancy time OCP is minimized. The coupling position determining unit 1208 calls out the simulator to calculate the optimal driving speed of the preceding train.

The coupling position determination unit 1208 utilizes the calculated driving speed of the following train and the preceding-train driving speed calculated as the output of the simulator as the basis for determining the meeting position of the preceding train 900 and the following train 902 as the temporary coupling position. The coupling position determining unit 1208 may calculate the travel distances of the preceding train 900 and the following train 902 from the preceding-train departure time. The coupling position determining unit 1208 may determine a point where the following train 902 travels on the joint track 1008 in the calculated driving speed and meets the preceding train 900 as the temporary coupling position. In the second embodiment, the coupling position determining unit 1208 may be responsive to when the temporary coupling position is included in the area of one of the multiple dwell stations for determining the platform of one of the dwell stations as the final coupling position. For example, when the preceding train 900 and the following train 902 can perform coupling at the platform of one of the multiple dwell stations, the coupling position determining unit 1208 determines that platform as the final coupling position. In another embodiment, the coupling position determining unit 1208 determines a calculated temporary coupling position as the final coupling position when no temporary coupling position is included in one of the multiple dwell stations. For example, upon determining that the preceding train 900 and the following train 902 cannot perform the coupling at the platform of one of the multiple dwell stations, the coupling position determination unit 1208 determines the temporary coupling position corresponding to the inter-station route as the final coupling position.

The train controller 1210 controls the speeds of the preceding train 900 and the following train 902, respectively, to recover the platooning between the two trains at the final coupling position [x*_{LF}]. Specifically, the coupling position determining apparatus 904 transmits the preceding-train control signal including the driving speed of the preceding train to the preceding train 900 based on wireless communications. The coupling position determining apparatus 904 transmits the following-train control signal including the driving speed of the following train to the following train 902 based on wireless communications.

With the operation of the coupling position determining apparatus 904 according to the second embodiment, even if coupling at the joint station is delayed, platooning between trains can be restored at another dwell station or in an inter-station route. The present disclosure provides a method of determining the departure time of the preceding train 900 to avoid additional delay when the coupling between trains is delayed. The second embodiment provides a method of determining an optimal position where coupling between trains is performed for platooning recovery. In the second embodiment, both the efficient use of the railway capacity and the securing of safety are considered for determining the coupling position.

In the second embodiment of the present disclosure, when platooning is implemented by coupling between trains at a redetermined coupling position, a driving distance needs to be properly secured between the coupled trains. For example, too short a driving distance would fail to provide a sufficient braking distance for the following train, increasing the risk of collision. On the other hand, too long a driving distance would decrease the efficiency of using the railway capacity. Therefore, the driving distance of trains is preferably determined by taking into account the balance between the efficiency of using the railway capacity and the securing of a safe distance for the following train.

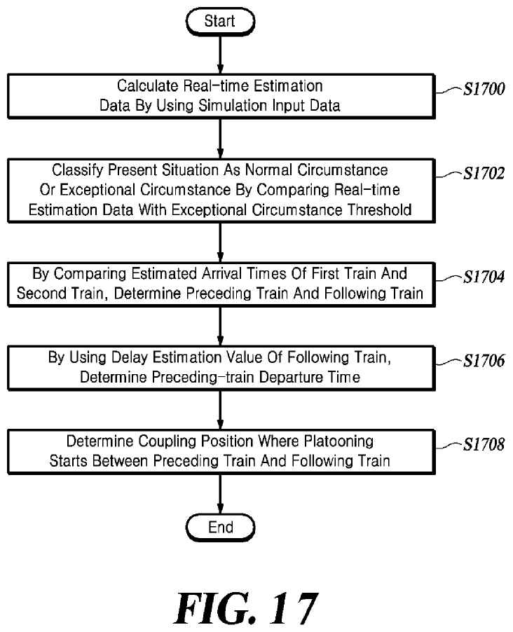

FIG. 17 is a flowchart illustrating the respective steps of the coupling position determining method according to the second embodiment of the present disclosure.

The following describes the respective steps included in the coupling position determining method by referring to FIG. 17. A repeat description of those presented by FIGS. 9 to 16 is omitted.

The arrival time calculation unit 1200 calculates real-time estimation data for one or more trains by using pre-stored simulation input data (S1700).

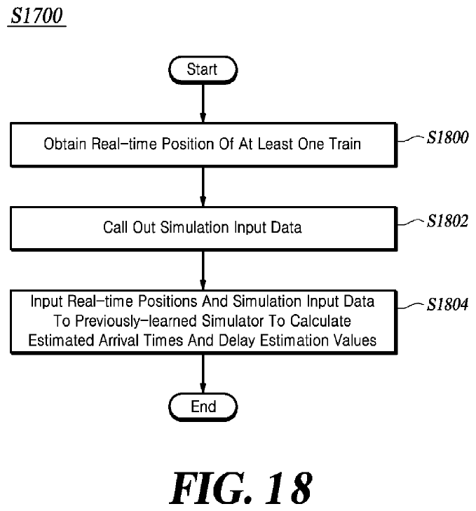

The estimated arrival time and delay estimation value included in the real-time estimation data have been described in FIG. 12, and hence reiterative details thereof will be omitted. A detailed process by which the arrival time calculation unit 1200 calculates the real-time estimation data will be described below with reference to FIG. 18.

The circumstance determining unit 1202 classifies the present railway traffic condition as a normal circumstance or an exceptional circumstance by comparing the real-time estimation data with the exceptional circumstance threshold (S1702). The exceptional circumstance threshold and the condition for the circumstance determining unit 1202 to detect the exceptional circumstance have been described in detail with reference to FIGS. 12 to 15B, and hence reiterative details thereof will be omitted.

The preceding train determining unit 1204 compares the estimated arrival times of the first train 1000 and the second train 1002 and determines the preceding train 900 and the following train 902 (S1704). An embodiment in which the preceding train determining unit 1204 determines the preceding train 900 and the following train 902 has been described in FIG. 12, and hence reiterative details thereof will be omitted.

The departure time determining unit 1206 determines the preceding-train departure time by using the delay estimation value of the following train (S1706). For example, the departure time determining unit 1206 determines the timing at which the delay of the following train 902 is predicted to be equal to or greater than the preceding waiting threshold as the departure time of the preceding train 900. Since the method of calculating the delay estimation value of the following train has been described in detail in FIG. 12 inclusive of the parameter of the preceding waiting threshold, and hence reiterative details thereof will be omitted.

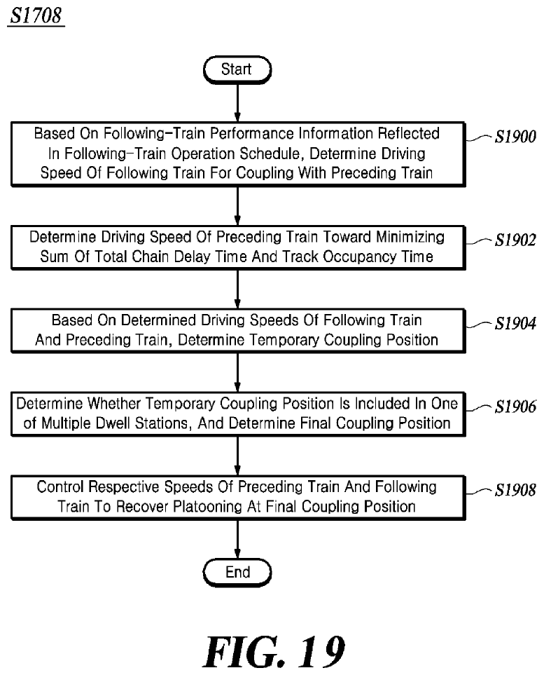

The coupling position determination unit 1208 determines the coupling position at which the platooning starts between the preceding train and the following train (S1708). A specific process for determining the coupling position by the coupling position determining unit 1208 will be described below with reference to FIG. 19.

FIG. 18 is a flowchart illustrating substeps of the real-time estimation data calculation step in the coupling position determining method according to the second embodiment of the present disclosure.

The arrival time calculation unit 1200 obtains the real-time location of at least one train from the coupling management initiation time based on wireless communications with the ATS or at least one train (S1800). In at least one embodiment, the arrival time calculation unit 1200 obtains respective real-time locations (x₁(t) and x₂(t)) of the first train and the second train planned to enter the joint station based on the current time.

The arrival time calculation unit 1200 calls out pre-stored simulation input data necessary for performing the simulation with respect to the sections extending from the real-time locations (x₁(t) and x₂(t)) of the trains to the dwell station (S1802). The specific data included in the simulation input data has been described in FIG. 12, and hence reiterative details thereof will be omitted.

The arrival time calculation unit 1200 inputs the real-time locations of the trains and simulation input data to the pre-learned simulator, and calculates estimated arrival times and delay estimation values (S1804). Since the method of calculating the delay estimation values by using the estimated arrival times has been described in FIG. 12, and hence reiterative details thereof will be omitted.

FIG. 19 is a flowchart illustrating substeps of the coupling position determination step in the coupling position determining method according to the second embodiment of the present disclosure.

The coupling position determining unit 1208 determines the driving speed of the following train for coupling with the preceding train based on the performance information of the following train reflected in the operation schedule of the following train (S1900). The coupling position determining unit 1208 may input the maximum performance information of the following train to the simulator and thereby calculate the driving speed of the following train for recovering platooning with the preceding train.

The coupling position determining unit 1208 determines the driving speed of the preceding train such that the sum of the total chain delay time and the track occupancy time is minimized (S1902). The coupling position determining unit 1208 may calculate the driving speed of the preceding train for recovering the platooning with the following train by using the simulator.

The coupling position determining unit 1208 determines a temporary coupling position between the preceding train and the following train based on the determined driving speeds of the following train and the preceding train after Step S1902 (S1904). The travel distance of a train may be calculated by multiplying the travel speed by the travel time. From the preceding-train departure time, the temporary coupling position may be produced by calculating the travel distances based on the driving speeds of the preceding train and the following train.

The coupling position determining unit 1208 determines whether the temporary coupling position is included in one of multiple dwell stations, and determines the final coupling position (S1906). Since the above has described the embodiment of determining the final coupling position according to whether the temporary coupling position is included in the area of the dwell station, further description thereof will be omitted.

The train controller 1210 controls the speeds of the preceding train 900 and the following train 902, respectively, to recover the platooning between the two trains at the final coupling position (S1908). Specifically, the coupling position determining apparatus 904 transmits the preceding-train control signal including the driving speed of the preceding train to the preceding train 900 based on wireless communications. The coupling position determining apparatus 904 transmits the following-train control signal including the driving speed of the following train to the following train 902 based on wireless communications.

According to the second embodiment, the present disclosure can be responsive to when a train accidentally deviates from the operation schedule for determining a coupling position such that virtual coupling is performed between the preceding train and the following train, thereby allowing train platooning to be recovered.

According to another embodiment, the present disclosure can reduce the track occupancy time of trains and increase the efficiency of the use of the track by determining the coupling position of the trains so that the coupling between the trains is still performed on the track other than the platform of the joint station.

Although some embodiments of the present disclosure present flowcharts with the steps thereof illustrated as being sequentially performed, they merely instantiate the technical idea of some embodiments of the present disclosure. Therefore, a person having ordinary skill in the pertinent art could incorporate various modifications, additions, and substitutions in practicing the present disclosure by changing the sequence of steps described by the respective flowcharts or by performing one or more of the steps in the flowcharts in parallel, and hence the steps in the respective flowcharts are not limited to the illustrated chronological sequences.

Various implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. Computer programs, which are also known as programs, software, software applications, or codes, contain instructions for a programmable processor and are stored in a “computer-readable recording medium.”

The computer-readable recording medium includes any types of recording device on which data that can be read by a computer system are recordable. Examples of computer-readable recording medium include non-volatile or non-transitory media such as a ROM, CD-ROM, magnetic tape, floppy disk, memory card, hard disk, optical/magnetic disk, storage devices, and the like. The computer-readable recording medium further includes transitory media such as data transmission medium. Further, the computer-readable recording medium can be distributed in computer systems connected via a network, wherein the computer-readable codes can be stored and executed in a distributed mode.

Various implementations of the systems and techniques described herein can be realized by a programmable computer. Here, the computer includes a programmable processor, a data storage system (including volatile memory, nonvolatile memory, or any other type of storage system or a combination thereof), and at least one communication interface. For example, the programmable computer may be one of a server, network equipment, a set-top box, an embedded device, a computer expansion module, a personal computer, a laptop, a personal data assistant (PDA), a cloud computing system, and a mobile device.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

What is claimed is:

1. A method performed by an apparatus for determining coupling and decoupling positions between trains, the method comprising:
collecting, by the apparatus, performance data on operation performance and dispatch performance of a train, simulation data on a situation not recorded in the performance data on operation performance and dispatch performance of the train, and real-time data on passenger information and train operation information recorded in real-time;
calculating, by the apparatus, a first parameter for determining whether a train is saturated and a second parameter for determining whether a railway traffic condition corresponds to an exceptional circumstance by using at least one of the performance data, the simulation data, the real-time data, and schedule data that is preset on operation and dispatch of the train; and
determining, by the apparatus, the coupling and decoupling positions between the trains based on the first parameter and the second parameter.

2. The method of claim 1, wherein the real-time data in the collecting comprises:
real-time tag data including information on a number of passengers passing through a gate in real-time and whether or not the passengers enter and exit; and
real-time operation data including information on a position and a driving speed of at least one train in operation in real-time.

3. The method of claim 1, wherein the performance data in the collecting comprises:
a tag performance representing accumulated records of passengers passing through a gate;
an operation performance representing a record of at least one train entering and exiting each of platforms;
an operation schedule performance representing an error between a preset operation schedule and an operation performance of at least one train; and
a dispatch schedule performance representing a deviation between a preset dispatch schedule and a dispatch record of at least one train.

4. The method of claim 1, wherein the schedule data in the calculating comprises:
a dispatch schedule which is information on a dispatch interval of at least one train; and
an operation schedule which is information on a position and a travel speed of the at least one train for complying with the dispatch schedule.

5. The method of claim 1, wherein the first parameter in the calculating comprises any one of:
a passenger occupancy ps(t) of a train;
a surplus cost cₛ⁺(t, c, d) corresponding to a positive deviation between a train capacity CAP(c, d) and the passenger occupancy; and
a shortage cost cₛ⁻(t, c, d) corresponding to a negative deviation between the train capacity and the passenger occupancy.

6. The method of claim 1, wherein the second parameter in the calculating comprises:
an occupancy parameter ΔP₁, ΔP₂;
a surplus parameter ΔC₁⁺, ΔC₂⁺; and
a shortage parameter ΔC₁⁻, ΔC₂⁻.

7. The method of claim 1, wherein the determining comprises:
calculating, based on the performance data and the simulation data, a case set E(c, d|∪(c, d)ₙ) which is a set of position determining cases for adjusting the coupling and decoupling positions between trains.

8. An apparatus for determining coupling and decoupling positions between trains, the apparatus comprising:
a data collection unit configured to collect performance data on operation performance and dispatch performance of a train, simulation data on a situation not recorded in the performance data on operation performance and dispatch performance of the train, and real-time data on passenger information and train operation information recorded in real-time;
a parameter calculation unit configured to calculate a first parameter for determining whether a train is saturated and a second parameter for determining whether a railway traffic condition corresponds to an exceptional circumstance by using at least one of the performance data, the simulation data, the real-time data, and schedule data that is preset on operation and dispatch of the train; and
a position determination unit configured to determine the coupling and decoupling positions between the trains based on the first parameter and the second parameter.

9. A non-transitory computer-readable recording medium having recorded thereon a program which when executed by a processor, causes the processor to perform operations comprising:
collecting performance data on operation performance and dispatch performance of a train, simulation data on a situation not recorded in the performance data on operation performance and dispatch performance of the train, and real-time data on passenger information and train operation information recorded in real-time;
calculating a first parameter for determining whether a train is saturated and a second parameter for determining whether a railway traffic condition corresponds to an exceptional circumstance by using at least one of the performance data, the simulation data, the real-time data, and schedule data that is preset on operation and dispatch of the train; and
determining a coupling and decoupling positions between the trains based on the first parameter and the second parameter.

10. A method performed by an apparatus for determining a coupling position between trains, the method comprising:
calculating, by the apparatus, real-time estimation data including an estimated arrival time at which at least one train is expected to arrive at a joint station and a delay estimation value of the train by using simulation input data that is pre-stored;
classifying, by the apparatus, a present situation into a normal circumstance or an exceptional circumstance by comparing the real-time estimation data with at least one exceptional circumstance threshold for determining an exceptional circumstance;
determining a preceding train and a following train by a comparison of estimated arrival times between a first train that is planned to enter the joint station first according to an operation schedule and a second train that is planned to enter the joint station subsequently and couple with the first train according to the operation schedule;
determining a preceding-train departure time for the preceding train to depart from the joint station by using a delay estimation value of the following train; and
determining the coupling position between the preceding train and the following train to start platooning.

11. The method of claim 10, wherein the calculating comprises:
obtaining a real-time location of the train;
calling the simulation input data; and
calculating the estimated arrival time and the delay estimation value by inputting the real-time location and the simulation input data to a pre-learned simulator.

12. The method of claim 11, wherein the simulation input data in the calling comprises:
railway information, an operation schedule that is preset, and a train specification.

13. The method of claim 11, wherein the calculating of the delay estimation value comprises:
calculating the delay estimation value by subtracting a scheduled arrival time on the operation schedule from the estimated arrival time.

14. The method of claim 10, wherein the exceptional circumstance threshold in the classifying comprises:
a following delay threshold regarding a delay limit of the following train;
an arrival deviation threshold regarding a difference limit between estimated arrival times of the preceding train and the following train; and
a preceding waiting threshold regarding a time limit for the preceding train to wait at the joint station.

15. The method of claim 14, wherein the classifying comprises:
classifying the present situation as the exceptional circumstance upon satisfaction of at least one of conditions including:
a first condition \dot{δ}ₛ_{₀}_{,2}≥T₀ indicating that the second train has a second delay estimation value that is equal to or greater than the following delay threshold;
a second condition \dot{δ}ₛ_{₀}_{,1}≥T₀ indicating that the first train has a first delay estimation value which is equal to or greater than the following delay threshold; and
a third condition |\dot{a}ₛ_{₀}_{,1}−\dot{a}ₛ_{₀}_{,2}|≥T₁ indicating that a first estimated arrival time of the first train and a second estimated arrival time of the second train differ by the arrival deviation threshold or more.

16. The method of claim 14, wherein the determining of the preceding-train departure time comprises:
determining a time at which the preceding train has a delay estimation value becoming equal to or greater than the preceding waiting threshold, as the preceding-train departure time.

17. The method of claim 10, wherein the determining of the coupling position comprises:
determining a driving speed of the following train for the following train to couple with the preceding train based on a train specification belonging to the following train and reflected in an operation schedule of the following train;
determining a driving speed of the preceding train to provide a minimized sum of a total chain delay time and a track occupancy time; and
determining, based on the driving speed of the following train and the driving speed of the preceding train, a position where the preceding train meets the following train as a temporary coupling position.

18. The method of claim 17, wherein the determining of the coupling position further comprises:
when the temporary coupling position is within premises of one dwell station of a plurality of dwell stations, determining a platform of the one dwell station as a final coupling position; and
controlling speeds of the preceding train and the following train, respectively, to restore the platooning between the preceding train and the following train at the final coupling position.

19. The method of claim 17, wherein the determining of the coupling position further comprises:
when the temporary coupling position is out of premises of one dwell station of a plurality of dwell stations, determining the temporary coupling position as a final coupling position; and
controlling speeds of the preceding train and the following train, respectively, to restore the platooning between the preceding train and the following train at the final coupling position.

20. An apparatus for determining a coupling position between trains, the apparatus comprising:
an arrival time calculation unit configured to calculate real-time estimation data including an estimated arrival time at which at least one train is expected to arrive at a joint station and a delay estimation value of the train by using simulation input data that is pre-stored;
a circumstance determining unit configured to classify a present situation into a normal circumstance or an exceptional circumstance by comparing the real-time estimation data with at least one exceptional circumstance threshold for determining an exceptional circumstance;
a preceding train determining unit configured to determine a preceding train and a following train by a comparison of estimated arrival times between a first train that is planned to enter the joint station first according to an operation schedule and a second train that is planned to enter the joint station subsequently and couple with the first train according to the operation schedule;
a departure time determining unit configured to determine a preceding-train departure time for the preceding train to depart from the joint station by using a delay estimation value of the following train; and
a coupling position determining unit configured to determine the coupling position between the preceding train and the following train to start platooning.
